(19) United States
(12) Patent Application Publication
(10) Pub. No.: US 2026/0353281 A1
(43) Pub. Date: Nov. 5, 2026

(54) FAILURE DETECTION FOR COMMUNICATION POWER STATE SWITCHING

(71) Applicant: QUALCOMM Incorporated, San Diego, CA (US)

(72) Inventors: Zhichao ZHOU, Beijing (CN); Ahmed ELSHAFIE, San Diego, CA (US); Diana MAAMARI, San Diego, CA (US); Prashanth Haridas HANDE, San Diego, CA (US)

(21) Appl. No.: 19/478,140

(22) PCT Filed: Jul. 6, 2023
(86) PCT No.: PCT/CN2023/106006

§ 371 Date: Oct. 23, 2025

(51) Int. Cl. H04W 52/02; H04W 24/04; H04W 76/38

(52) U.S. Cl. CPC H04W 52/0216; H04W 24/04; H04W 52/0235; H04W 76/38

(57) ABSTRACT

Methods, systems, and devices for wireless communication are described. A user equipment (UE) may receive, from a network entity, control information indicating a first schedule for the UE to transition between a set of power states. The UE may determine to perform a radio link failure (RLF) or beam failure (BF) detection operation for a radio link or beam used to communicate with the network entity. The UE may apply a second schedule to transition between the set of power states based on the determination. The second schedule may include a postponement of a transition to a power state of the set of power states. The UE may perform an RLF or BF detection operation based on applying the second schedule. Additionally, or alternatively, the UE may modify operation of a hybrid automatic repeat request (HARQ) round trip time timer based on a power state in which the UE operates.

### CROSS REFERENCE

The present Application is a 371 national phase filing of International PCT Application No. PCT/CN2023/106006 by ZHOU et al., entitled “FAILURE DETECTION FOR COMMUNICATION POWER STATE SWITCHING,” filed Jul. 6, 2023, which is assigned to the assignee hereof, and which is expressly incorporated by reference in its entirety herein.

### FIELD OF TECHNOLOGY

The following relates to wireless communication, including failure detection for communication power state switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support failure detection for communication power state switching. For example, the described techniques provide for a user equipment (UE) to receive, from a network entity in communication with the UE, control information indicating a first schedule for the UE to transition between a set of power states. The power states may include at least an uplink-only power state and a second power state, such as a downlink-and-uplink power state. The UE may determine to perform a radio link failure (RLF) or beam failure (BF) detection operation for a radio link or beam used to communicate with the network entity. The UE may apply a second schedule (e.g., different from the first schedule) to transition between the set of power states based on the determination. The second schedule may include a postponement of a transition of the UE between power states. For instance, the second schedule may indicate that the UE is to postpone a transition from the downlink-and-uplink power state to the uplink-only state. The UE may perform an RLF or BF detection operation based on applying the second schedule, e.g., before transitioning to the uplink-only state.

In some examples, the control information includes or is an example of downlink control information (DCI). In some cases, the UE may receive an indication that triggers the UE to perform the RLF or BF detection operation, such as within the DCI or as an indication associated with a wake-up signal (WUS). For example, the network entity may monitor a quality of the radio link or one or more beams. If the quality becomes poor, the network entity may trigger the UE to apply the second schedule (e.g., to postpone the transition to the uplink-only state) and to perform the RLF or BF detection operation. Additionally, or alternatively, the UE may modify operation of a hybrid automatic repeat request (HARQ) round trip time (RTT) timer based on a power state in which the UE operates. For instance, the UE may pause, resume, initiate, or refrain from initiating the HARQ RTT timer in accordance with the power state.

A method for wireless communication by a UE is described. The method may include receiving control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, determining that the UE is to perform a RLF or BF detection operation, and applying a second schedule for the UE to transition between the set of multiple power states based on the determination that the UE is to perform the RLF or BF detection operation.

A UE for wireless communication is described. The UE may include one or more memories storing processor-executable code and one or more processors coupled with the one or more memories and individually or collectively operable to execute the code to cause the UE to receive control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, determine that the UE is to perform a RLF or BF detection operation, and apply a second schedule for the UE to transition between the set of multiple power states based on the determination that the UE is to perform the RLF or BF detection operation.

Another UE for wireless communication is described. The UE may include means for receiving control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, means for determining that the UE is to perform a RLF or BF detection operation, and means for applying a second schedule for the UE to transition between the set of multiple power states based on the determination that the UE is to perform the RLF or BF detection operation.

A non-transitory computer-readable medium storing code for wireless communication by a UE is described. The code may include instructions executable by one or more processors to receive control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, determine that the UE is to perform a RLF or BF detection operation, and apply a second schedule for the UE to transition between the set of multiple power states based on the determination that the UE is to perform the RLF or BF detection operation.

In some examples of the method, apparatuses, and non-transitory computer-readable medium described herein, determining that the UE may perform the RLF or BF detection operation may include operations, features, means, or instructions for receiving a DCI message that activates the RLF or BF detection operation, where applying the second schedule may be based on receipt of the DCI message.

In some examples of the method, apparatuses, and non-transitory computer-readable medium described herein, the second schedule includes a postponement of a transition from the second state to the uplink-only state until after an expiration of a failure detection timer associated with the RLF or BF detection operation.

In some examples of the method, apparatuses, and non-transitory computer-readable medium described herein, receiving the DCI message may include operations, features, means, or instructions for receiving an indication that the UE may be to apply the second schedule.

In some examples of the method, apparatuses, and non-transitory computer-readable medium described herein, determining that the UE may be to perform the RLF or BF detection operation may include operations, features, means, or instructions for receiving a WUS associated with an indication that the UE may be to perform the RLF or BF detection operation, where applying the second schedule may be based on receipt of the WUS, and where the second schedule includes a postponement of a transition from the second state to the uplink-only state and performing the RLF or BF detection operation after applying the second schedule.

In some examples of the method, apparatuses, and non-transitory computer-readable medium described herein, the WUS includes an indication of the second schedule and the second schedule includes a transition to the uplink-only state after completion of the RLF or BF detection operation.

In some examples of the method, apparatuses, and non-transitory computer-readable medium described herein, the control information further indicates a set of multiple schedules for the UE to transition between the set of multiple power states and the method, apparatuses, and non-transitory computer-readable medium may include further operations, features, means, or instructions for receiving a priority indication associated with the RLF or BF detection operation and selecting the second schedule from the set of multiple schedules based on the priority indication of the RLF or BF detection operation.

In some examples of the method, apparatuses, and non-transitory computer-readable medium described herein, selecting the second schedule from the set of multiple schedules may include operations, features, means, or instructions for selecting the second schedule based on an association between the respective timer duration of the second schedule and the priority indication.

In some examples of the method, apparatuses, and non-transitory computer-readable medium described herein, the association includes that a higher priority may be associated with a longer timer duration prior to a transition from the second state to the uplink-only state and a lower priority may be associated with a shorter timer duration prior to the transition from the second state to the uplink-only state.

In some examples of the method, apparatuses, and non-transitory computer-readable medium described herein, determining that the UE may be to perform the RLF or BF detection operation may include operations, features, means, or instructions for receiving a WUS associated with an indication that the UE may be to perform the RLF or BF detection operation, where applying the second schedule may be based on receipt of the WUS, and where the second schedule includes a transition from the uplink-only state to the second state.

Some examples of the method, apparatuses, and non-transitory computer-readable medium described herein may further include operations, features, means, or instructions for receiving an indication of a duration of time from receipt of the WUS and the transition from the uplink-only state to the second state.

Some examples of the method, apparatuses, and non-transitory computer-readable medium described herein may further include operations, features, means, or instructions for performing the RLF or BF detection operation and detecting at least one failure instance during the RLF or BF detection operation, where applying the second schedule may be based on detecting the at least one failure instance, and where the second schedule includes a postponement of a transition from the second state to the uplink-only state.

In some examples of the method, apparatuses, and non-transitory computer-readable medium described herein, the postponement of the transition from the second state to the uplink-only state may be until after an expiration of a failure detection timer associated with the RLF or BF detection operation.

In some examples of the method, apparatuses, and non-transitory computer-readable medium described herein, the control information further indicates a set of multiple schedules for the UE to transition between the set of multiple power states and the method, apparatuses, and non-transitory computer-readable medium may include further operations, features, means, or instructions for selecting the second schedule from the set of multiple schedules based on detecting the at least one failure instance.

Some examples of the method, apparatuses, and non-transitory computer-readable medium described herein may further include operations, features, means, or instructions for transmitting an uplink message including an indication that the second schedule may be applied and receiving, based on transmitting the uplink message, one or more downlink signals for performing the RLF or BF detection operation, where the uplink message may be one of an uplink control information message, a medium access control (MAC) control element (CE), or a physical uplink shared channel message to which the indication may be piggybacked.

A method for wireless communication by a network entity is described. The method may include transmitting, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, determining that the UE is to perform a RLF or BF detection operation, and transmitting, to the UE, a message that triggers the UE to transition from the first schedule to a second schedule for the UE to transition between the set of multiple power states based on the determination that the UE is to perform the RLF or BF detection operation.

A network entity for wireless communication is described. The network entity may include one or more memories storing processor-executable code; and one or more processors coupled with the one or more memories and individually or collectively operable to execute the code to cause the network entity to transmit, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, determine that the UE is to perform a RLF or BF detection operation, and transmit, to the UE, a message that triggers the UE to transition from the first schedule to a second schedule for the UE to transition between the set of multiple power states based on the determination that the UE is to perform the RLF or BF detection operation.

Another network entity for wireless communication is described. The network entity may include means for transmitting, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, means for determining that the UE is to perform a RLF or BF detection operation, and means for transmitting, to the UE, a message that triggers the UE to transition from the first schedule to a second schedule for the UE to transition between the set of multiple power states based on the determination that the UE is to perform the RLF or BF detection operation.

A non-transitory computer-readable medium storing code for wireless communication by a network entity is described. The code may include instructions executable by one or more processors to transmit, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions, determine that the UE is to perform a RLF or BF detection operation, and transmit, to the UE, a message that triggers the UE to transition from the first schedule to a second schedule for the UE to transition between the set of multiple power states based on the determination that the UE is to perform the RLF or BF detection operation.

In some examples of the method, apparatuses, and non-transitory computer-readable medium described herein, transmitting the message that triggers the UE to transition from the first schedule to the second schedule may include operations, features, means, or instructions for transmitting a DCI message that activates the RLF or BF detection operation.

In some examples of the method, apparatuses, and non-transitory computer-readable medium described herein, the second schedule includes a postponement of a transition from the second state to the uplink-only state until after an expiration of a failure detection timer associated with the RLF or BF detection operation.

In some examples of the method, apparatuses, and non-transitory computer-readable medium described herein, the DCI message includes an indication that the UE may be to apply the second schedule.

In some examples of the method, apparatuses, and non-transitory computer-readable medium described herein, transmitting the message that triggers the UE to transition from the first schedule to the second schedule may include operations, features, means, or instructions for transmitting a WUS associated with an indication that the UE may be to perform the RLF or BF detection operation, where the second schedule includes a postponement of a transition from the second state to the uplink-only state.

In some examples of the method, apparatuses, and non-transitory computer-readable medium described herein, the WUS includes an indication of the second schedule and the second schedule includes a transition to the uplink-only state after completion of the RLF or BF detection operation.

In some examples of the method, apparatuses, and non-transitory computer-readable medium described herein, the message that triggers the UE to transition from the first schedule to the second schedule further indicates a set of multiple schedules for the UE to transition between the set of multiple power states and the method, apparatuses, and non-transitory computer-readable medium may include further operations, features, means, or instructions for transmitting a priority indication associated with the RLF or BF detection operation.

In some examples of the method, apparatuses, and non-transitory computer-readable medium described herein, each of the set of multiple schedules includes a respective timer duration for postponement of a transition from the second state to the uplink-only state.

In some examples of the method, apparatuses, and non-transitory computer-readable medium described herein, transmitting the message that triggers the UE to transition from the first schedule to the second schedule may include operations, features, means, or instructions for transmitting a WUS associated with an indication that the UE may be to perform the RLF or BF detection operation, where the second schedule includes a transition from the uplink-only state to the second state.

Some examples of the method, apparatuses, and non-transitory computer-readable medium described herein may further include operations, features, means, or instructions for transmitting an indication of a duration of time from receipt of the WUS and the transition from the uplink-only state to the second state.

Some examples of the method, apparatuses, and non-transitory computer-readable medium described herein may further include operations, features, means, or instructions for receiving an uplink message including an indication that the second schedule may be applied at the UE and transmitting, based on receiving the uplink message, one or more downlink signals for the RLF or BF detection operation at the UE, where the uplink message may be one of an uplink control information message, a MAC-CE, or a physical uplink shared channel message to which the indication may be piggybacked.

A method for wireless communication by a UE is described. The method may include receiving control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions, transmitting an uplink message, and modifying operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

A UE for wireless communication is described. The UE may include one or more memories storing processor-executable code; and one or more processors coupled with the one or more memories and individually or collectively operable to execute the code to cause the UE to receive control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions, transmit an uplink message, and modify operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

Another UE for wireless communication is described. The UE may include means for receiving control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions, means for transmitting an uplink message, and means for modifying operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

A non-transitory computer-readable medium storing code for wireless communication by a UE is described. The code may include instructions executable by one or more processors to receive control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions, transmit an uplink message, and modify operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

In some examples of the method, apparatuses, and non-transitory computer-readable medium described herein, modifying operation of the HARQ RTT timer may include operations, features, means, or instructions for pausing the HARQ RTT timer based on the first state being the downlink-only state.

In some examples of the method, apparatuses, and non-transitory computer-readable medium described herein, modifying operation of the HARQ RTT timer may include operations, features, means, or instructions for refraining from initiating the HARQ RTT timer based on the first state being the uplink-only state.

In some examples of the method, apparatuses, and non-transitory computer-readable medium described herein, modifying operation of the HARQ RTT timer may include operations, features, means, or instructions for initiating the HARQ RTT timer based on the first state being the downlink-only state or the downlink and uplink state.

In some examples of the method, apparatuses, and non-transitory computer-readable medium described herein, modifying operation of the HARQ RTT timer may include operations, features, means, or instructions for pausing the HARQ RTT timer based on the first state being the uplink-only state.

Some examples of the method, apparatuses, and non-transitory computer-readable medium described herein may further include operations, features, means, or instructions for transitioning to a second state of the set of multiple power states, the second state being one of the downlink-only state or the downlink and uplink state and resuming the HARQ RTT timer based on the second state being the downlink-only state or the downlink and uplink state.

### BRIEF DESCRIPTION OF THE DRAWINGS

FIG. 1 shows an example of a wireless communications system that supports failure detection for communication power state switching in accordance with one or more aspects of the present disclosure.

FIG. 2 shows an example of a wireless communications system that supports failure detection for communication power state switching in accordance with one or more aspects of the present disclosure.

FIGS. 3A and 3B show examples of communication timelines that support failure detection for communication power state switching in accordance with one or more aspects of the present disclosure.

FIGS. 4 and 5 show examples of process flows that support failure detection for communication power state switching in accordance with one or more aspects of the present disclosure.

FIGS. 6 and 7 show block diagrams of devices that support failure detection for communication power state switching in accordance with one or more aspects of the present disclosure.

FIG. 8 shows a block diagram of a communications manager that supports failure detection for communication power state switching in accordance with one or more aspects of the present disclosure.

FIG. 9 shows a diagram of a system including a device that supports failure detection for communication power state switching in accordance with one or more aspects of the present disclosure.

FIGS. 10 and 11 show block diagrams of devices that support failure detection for communication power state switching in accordance with one or more aspects of the present disclosure.

FIG. 12 shows a block diagram of a communications manager that supports failure detection for communication power state switching in accordance with one or more aspects of the present disclosure.

FIG. 13 shows a diagram of a system including a device that supports failure detection for communication power state switching in accordance with one or more aspects of the present disclosure.

FIGS. 14 through 19 show flowcharts illustrating methods that support failure detection for communication power state switching in accordance with one or more aspects of the present disclosure.

### DETAILED DESCRIPTION

In some wireless communications systems, wireless devices, (e.g., user equipments (UEs), network entities) may support one or more power states. A wireless device may operate in a power state based on tradeoffs between communication performance and power savings. For example, some power states may be associated with operations, parameters, or behaviors that reduce power consumption at the wireless device. Other power states may be configured to support relatively high data throughput, e.g., at the cost of increased power consumption. A wireless device may switch between power states to adapt to various scenarios, to achieve appropriate performance, or based on respective directional communication profiles corresponding each power state. For instance, the wireless device may utilize different power states based on compensating for changes in channel conditions, meeting quality of service (QoS) requirements, or conserving power.

In some cases, the wireless device may use, or refrain from using, a primary radio or other circuitry of the wireless device for transmission and reception in one or more communication directions based on a power state in which the wireless device operates. In a downlink-and-uplink power state, the primary radio may be used to both transmit and receive uplink and downlink messages, respectively. Alternatively, refraining from communicating in at least one communication direction may conserve power at the wireless device, e.g., by allowing the wireless device to turn off transmission or reception circuitry. For example, in an uplink-only power state, a primary radio of the wireless device may be used to transmit uplink messages, and may not be used to receive downlink messages; the wireless device may therefore reduce power consumption associated with downlink reception and processing. In a downlink-only power state, the wireless device may use the primary radio to receive downlink messages and may not receive uplink messages, thereby reducing power consumption associated with uplink transmissions.

As a result, however, some power states may restrict or prohibit certain operations at the wireless device. For example, when operating in the uplink-only power state, the wireless device may not receive or process (e.g., decode) downlink signals, such as physical downlink control channels (PDCCHs), physical downlink shared channels (PDSCHs), or the like. Thus, the wireless device may be unable to perform operations that rely on reception of downlink signals, such as radio link failure (RLF) detection and recovery, or beam failure (BF) detection and recovery, among other examples. In such examples, if a communication link between the wireless device and a second wireless device (e.g., a UE, a network entity) suffers performance degradation during operation in the uplink-only state, or if a beam of the communication link fails, the wireless device may lose its connection to the second wireless device and may be unable to perform a recovery procedure.

Accordingly, the present disclosure provides techniques for a wireless device to transition between power states based on failure detection and recovery. The described techniques may enable the wireless device to avoid entering into a power state, such as a low-power state (e.g., an uplink-only state, a downlink-only power state, a modem-off state), with a relatively low quality beam or communication link. That is, if the wireless device determines that RLF or BF is relatively likely, the wireless device may postpone a transition to the low-power state in order to perform an RLF/BF detection operation. In some examples, the wireless device may be configured to apply a schedule that includes the postponement.

For example, the wireless device may be configured with a first schedule for transitioning between a set of power states, which may include at least an uplink-only power state and a second power state (e.g., a downlink-only power state, a downlink-and-uplink power state). The wireless device may determine that the wireless device is to perform an RLF/BF detection operation for a radio link or beam used to communicate with a second wireless device, such as a network entity. Based on the determination, the wireless device may apply a second schedule for transitioning between the set of power states. The second schedule may include a postponement of a transition of the wireless device between power states. For example, the wireless device may operate in the second power state, which may be an example of a downlink-and-uplink power state. The first schedule may indicate that the wireless device is to transition to an uplink-only power state, while the second schedule may include a postponement of the transition to the uplink-only power state. Based on determining to perform the RLF/BF detection operation, the wireless device may apply the second schedule and may refrain from transitioning to the uplink-only power state. That is, the wireless device may perform the RLF/BF detection operation while the wireless device is operating in a power state in which it is able to receive downlink signals.

In some cases, the wireless device may receive (e.g., from the network entity) an indication that triggers the wireless device to perform the RLF or BF detection operation, such as within control information (e.g., downlink control information (DCI)) or as an indication associated with a wake-up signal (WUS). For example, the network entity may monitor a quality of the radio link or one or more beams. If the quality becomes poor, the network entity may trigger the UE to apply the second schedule (e.g., to postpone the transition to the uplink-only state). Additionally, or alternatively, the wireless device may modify operation of a hybrid automatic repeat request (HARQ) round trip time (RTT) timer based on a power state in which the wireless device operates. For instance, the wireless device may pause, resume, initiate, or refrain from initiating the HARQ RTT timer in accordance with the power state.

Aspects of the disclosure are initially described in the context of wireless communications systems. Aspects of the disclosure are then discussed with reference to communication timelines and process flows. Aspects of the disclosure are further illustrated by and described with reference to apparatus diagrams, system diagrams, and flowcharts that relate to failure detection for communication power state switching.

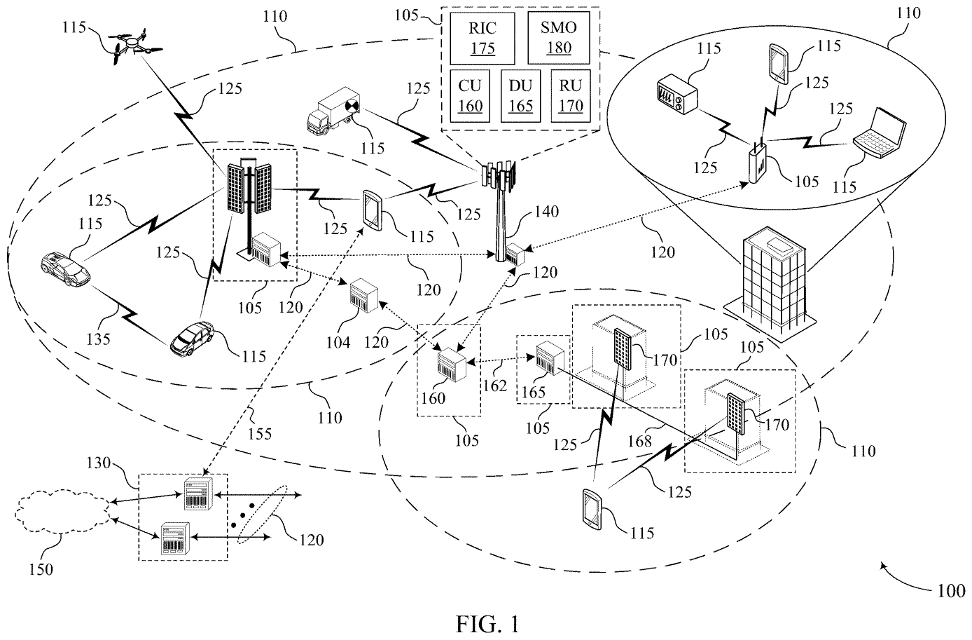

FIG. 1 shows an example of a wireless communications system 100 that supports failure detection for communication power state switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support failure detection for communication power state switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUS 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support multiple power states (e.g., network power states, network energy states, UE power states) for wireless devices, such as UEs 115 and network entities 105. Each power state may be associated with a configuration of a wireless device tailored for a respective traffic profile. That is, a power state may include or be an example of a set of parameters or behaviors that optimize operation of the wireless device in a corresponding communication state. For instance, some power states may be configured for high data rate or high throughput communications, while other power states may be configured for low data rate communications or low power consumption. A low-power state may refer to a power state in which a wireless device turns off circuitry for one or more (e.g., all) communication directions. In an uplink-only power state, for example, the wireless device may turn off reception circuitry, while in a downlink-only power state, the wireless device may turn off transmission circuitry. In a modem-off state, the wireless device may turn off all modems (e.g., both transmission and reception circuitry) and may not transmit or receive. In some cases, a power state may be configured to achieve maximum power savings while meeting quality of service (QOS) requirements for a corresponding traffic profile.

A wireless device may transition between power states to adapt to different communication scenarios or traffic profiles based on one or more timers, one or more schedules, changes in traffic profiles, feedback information, or receiving an indication. A UE 115, for example, may transition from a first power state to a second power state based on receiving control signaling (e.g., DCI, MAC-CE) from a network entity 105, where the control signaling indicates the second power state to the UE 115. The UE 115 may transition from the second power state back to the first power state based on expiry of a timer at the UE 115. In other examples, the UE 115 may transition between power states based on satisfying a condition. For instance, the condition may be satisfied based on the UE 115 initiating a retransmission timer, transmitting a negative acknowledgment message for one or more downlink messages, operating in an activation period of the second power state, receiving a burst of downlink messages, receiving a second control message indicating the second power state, expiration of a timer, or any combination thereof. In yet another example, the UE 115 may be configured to periodically transition between a first power state associated with relatively low power consumption and a second power state associated with relatively high data throughput, e.g., according to a duty cycle, a schedule, one or more timers, or the like.

To maintain communication with the network entity 105, the UE 115 may be configured to perform RLF detection and recovery, BF detection and recovery, or some combination thereof, for a communication link 125 (e.g., a radio link) between the UE 115 and the network entity 105. The communication link 125, and one or more beams (e.g., beam pairs) used for communication via the communication link 125, may be susceptible to blockage, interruptions, and degradation, which may disrupt the UE 115's ability to communicate with the network entity 105. BF may be understood as a connection failure of a beam, and the UE 115 may reestablish connection with the network entity 105 by switching beams used to communicate with the network entity 105 during a beam recovery procedure. RLF may occur when the UE 115 fails to connect to the network entity 105, for example, if the UE 115 is unable to find any suitable beam or if the UE 115 is unable to perform a successful random access procedure with the network entity 105.

To detect RLF or BF, the UE 115 and the network entity 105 may monitor a quality of the communication link 125 and the one or more beams. The network entity 105 may configure (e.g., RRC configure) the UE 115 with a set of resources and one or more parameters to use for RLF/BF detection and recovery. The network entity 105 may transmit, to the UE 115, one or more downlink signals (e.g., one or more downlink reference signals, such as synchronization signal blocks (SSBs), channel state information (CSI) reference signals (CSI-RS), or the like) using the one or more beams, and the UE 115 may perform one or more measurements based on receiving the one or more downlink signals. The UE 115 may detect a beam failure instance (BFI) for a beam when a measurement value (e.g., a reference signal received power (RSRP), a reference signal received quality (RSRQ), a signal-to-interference plus noise ratio (SINR)) of a downlink signal transmitted using the beam is below a signal quality threshold (e.g., as configured by the network entity 105). BF may occur when the UE 115 detects a threshold quantity of BFIs for the beam.

Upon detection of BF, the UE 115 may initiate a recovery procedure (e.g., a beam recovery procedure), in which the UE 115 searches for new candidate beams. The UE 115 may select a best candidate beam during the recovery procedure by receiving and measuring downlink reference signals received using respective beams (e.g., in accordance with the configured set of resources), where a “best” candidate beam refers to a beam with a best signal quality relative to other beams. The UE 115 may initiate a random access procedure with the network entity 105 using the selected beam. For example, the UE 115 may transmit a random access preamble to the network entity 105 using the selected beam. In some cases, the UE 115 may assume RLF if, after detecting BF, the UE 115 is unable to recover the connection during the beam recovery procedure.

Because RLF/BF detection and recovery procedures utilize downlink reference signals, the UE 115 may be unable to reestablish connection with the network entity 105 when operating in some power states, such as the uplink-only power state.

That is, in the uplink-only power state, the UE 115 may not receive or decode downlink signals including those used in the RLF/BF detection and recovery procedures. Thus, if RLF or BF occurs during operation in the uplink-only state, the UE 115 may suffer performance degradation, increased latency, reduced communications reliability, and the like.

According to the techniques described herein, the UE 115 operating in a first power state (e.g., a downlink-only power state, a downlink-and-uplink power state, or the like) may postpone a transition to a second power state (e.g., an uplink-only state, a modem-off state) if the UE 115 determines that an RLF/BF detection operation is necessary. In some aspects, the UE 115 may be triggered to initiate the RLF/BF detection operation by the network entity 105. For instance, the network entity 105 may transmit, and the UE 115 may receive, a signal (e.g., DCI, a WUS) that activates the RLF/BF detection operation. In other examples, the UE 115 may autonomously determine to perform an RLF/BF detection operation, for instance, based on detecting one or more BFIs.

The network entity 105 may configure the UE 115 with a first schedule for transitioning between a set of power states, which may include at least the first power state and the second power state. Based on determining that the UE 115 is to perform the RLF/BF detection operation, the UE 115 may apply a second schedule (e.g., different from the first scheduled) for transitioning between the set of power states. The second schedule may include a postponement of a transition of the UE 115 between power states such that the UE 115 refrains from transitioning to the second power state based on applying the second schedule. The UE 115 may perform the RLF/BF detection operation while the UE 115 is operating in the first power state (e.g., in which the UE 115 is able to receive downlink signals). Additionally, or alternatively, the UE 115 may modify operation of a HARQ RTT timer based on a power state in which the UE 115 operates. For instance, the UE 115 may pause, resume, initiate, or refrain from initiating the HARQ RTT timer in accordance with the power state.

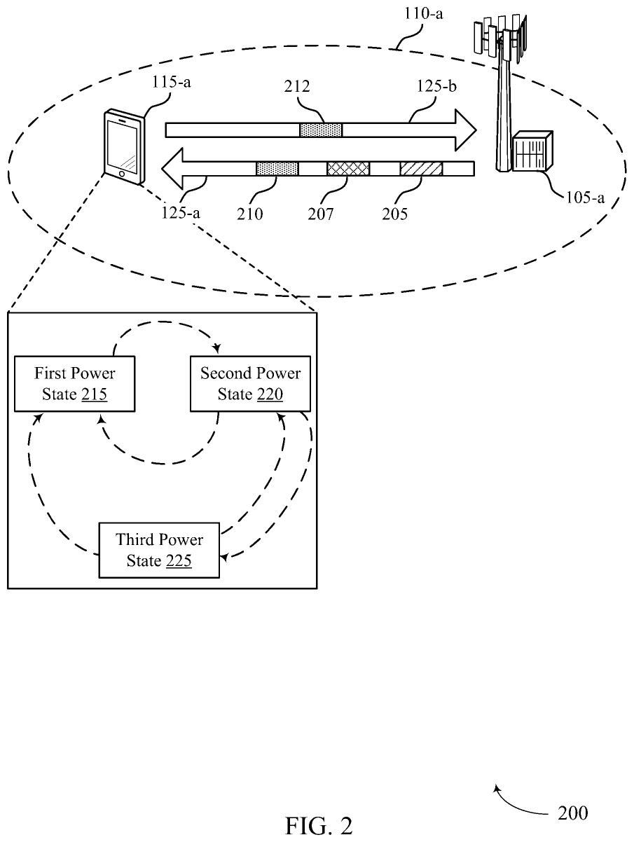

FIG. 2 shows an example of a wireless communications system 200 that supports failure detection for communication power state switching in accordance with one or more aspects of the present disclosure. For example, the wireless communications system 200 may include one or more network entities 105 (e.g., a network entity 105-a) and one or more UEs 115 (e.g., a UE 115-a), which may be examples of the corresponding devices as described with reference to FIG. 1. The wireless communications system 200 may support the use of one or more schedules for transitioning between power states based on RLF/BF detection.

In the wireless communications system 200, the UE 115-a and the network entity 105-a may communicate via one or more communication links 125 in a coverage area 110-a. For example, the network entity 105-a may transmit downlink signals, such as a control message 205, a DCI 207, or a WUS 210, via a communication link 125-a, which may include or be an example of a downlink communication link (e.g., PDCCH, PDSCH). The UE 115-a may monitor the communication link 125-a to detect, receive, and decode the downlink signals. Additionally, or alternatively, the UE 115-a may transmit uplink signals, such as an uplink message 212, to the network entity 105-a via a communication link 125-b, which may include or be an example of an uplink communication link (e.g., physical uplink control channel (PUCCH), physical uplink shared channel (PUSCH)). The network entity 105-a may monitor the communication link 125-b to detect, receive, and decode the uplink signals.

The UE 115-a and the network entity 105-a may implement RLF/BF detection and recovery operations to maintain the communication links 125. The network entity 105-a may transmit control signaling (e.g., RRC signaling), such as the control message 205, to the UE 115-a that indicates a configuration (e.g., an RRC configuration) for RLF/BF detection and recovery. The control message 205 may include, for example, an RLF detection and recovery configuration (e.g., RadioLinkMonitoringConfig), a BF detection and recovery configuration (e.g., BeamFailureRecoveryConfig), or a combination thereof, and may indicate one or more parameters for performing RLF/BF detection and recovery operations at the UE 115-a. The one or more parameters may include or be an example of a threshold quantity of BFIs (e.g., BeamFailureInstanceMaxCount), one or more time durations for one or more timers (e.g., BeamFailureDetectionTimer, BeamFailureRecoveryTimer), or resources for beam selection during a recovery procedure (e.g., failureDetectionResourcesToAddModList, failureDetectionResourcesToReleaseList), among other examples.

To perform an RLF/BF detection operation, the network entity 105-a may use one or more beams to transmit downlink reference signals to the UE 115-a via the communication link 125-a. The UE 115-a may measure the downlink reference signals to obtain, for the communication link 125-a or the one or more beams, one or more measurement values associated with signal strength, signal quality, or the like (e.g., RSRP, RSRQ, SINR). The UE 115-a may determine whether RLF or BF has occurred (e.g., may detect RLF or BF) based on the measurement values of the associated communication link 125-a, the one or more beams, or a combination thereof. For example, a BFI may refer to an instance in which the UE 115-a measures a reference signal as having a signal quality that fails to satisfy a threshold (e.g., a signal quality threshold, such as an RSRP value threshold, or an error rate threshold, such as an estimated block error rate (BLER) of a hypothetical PDCCH). The UE 115-a may detect BF based on detecting a threshold quantity of BFIs (e.g., beamFailureInstanceMaxCount) and may initiate a beam recovery procedure based on detecting BF. If the UE 115-a fails to perform beam recovery and can no longer establish a connection with the network entity 105-a, the UE 115-a may detect RLF and may initiate a radio link recovery procedure.

RLF/BF detection operations may be combined layer one (L1) (e.g., a physical (PHY) layer) and layer two (L2) (e.g., a MAC layer) procedures. The L1 of the UE 115-a may detect a BFI by detecting that a reference signal of a serving beam fails to satisfy a threshold. The LI may indicate the BFI to the MAC layer. The MAC layer may initiate a beam failure detection timer (e.g., BeamFailureDetectionTimer) and a counter (e.g., BFI_COUNTER) based on receiving an indication of a BFI from the L1. The MAC layer may increment the counter by one (1) for each BFI occurring within the duration of the beam failure detection timer. In some examples, the MAC layer may additionally reset the beam failure detection timer each time the MAC layer receives an indication of a BFI. When a value of the counter exceeds the threshold quantity of BFIs (e.g., beamFailureInstanceMaxCount), the MAC layer may determine that BF has occurred and may trigger (e.g., initiate) a beam recovery procedure. Alternatively, if a signal quality has improved and the L1 no longer detects BFI, the MAC layer may determine not to perform beam recovery. For example, if the MAC layer does not receive any BFI indications from the L1 and the beam failure detection timer expires (e.g., if the L1 does not detect any BFIs within the duration of the beam failure detection timer), the MAC layer may reset the counter and may not perform the beam recovery procedure. The UE 115-a may instead continue to use the same serving beam.

In some aspects, the UE 115-a may be triggered to initiate an RLF/BF detection operation by the network entity 105-a. For instance, the network entity 105-a may monitor a quality of the communication links 125 and the one or more beams to detect RLF or BF. If the network entity 105-a determines that the quality of the communication links 125 or the one or more beams is relatively poor, or if the network entity 105-a detects a threshold quantity of BFIs, the network entity 105-a may transmit, and the UE 115-a may receive, a signal (e.g., the DCI 207, the WUS 210) that activates the RLF/BF detection operation. In another example, the UE 115-a may detect one or more BFIs and may report the one or more BFIs (e.g., may transmit an indication of the one or more BFIs) to the network entity 105-a, for instance, in the uplink message 212. Based on receiving the uplink message 212, the network entity 105-a may activate the RLF/BF detection operation by transmitting control signaling, such as the DCI 207, to the UE 115-a. Alternatively, the UE 115-a may autonomously determine to perform an RLF/BF detection operation, for instance, based on detecting one or more BFIs.

If the UE 115-a, the network entity 105-a, or both detect RLF or BF for a communication link 125 or the one or more beams, the UE 115-a may perform an RLF/BF recovery operation. Upon detection of BF, or based on receiving control signaling to activate a recovery procedure, the UE 115-a may initiate the recovery procedure (e.g., a beam recovery procedure) in which the UE 115-a searches for new candidate beams using the resources indicated in the control message 205. The UE 115-a may select a best beam from the candidate beams and may initiate a random access procedure with the network entity 105-a using the selected beam. For example, the UE 115-a may transmit a random access preamble to the network entity 105-a using the selected beam. In some cases, the UE 115-a may assume RLF if, after detecting BF, the UE 115-a is unable to recover the connection during the beam recovery procedure. For instance, in some examples, the MAC layer may initiate a beam failure recovery timer (e.g., BeamFailureRecoveryTimer) upon triggering the beam recovery procedure. If the UE 115-a fails to select a candidate beam before the beam failure recovery timer expires, the UE 115-a may determine that the BF recovery operation has failed. To recover from RLF, the UE 115-a may search for a new candidate cell with which to attempt a connection establishment procedure (e.g., a random access procedure).

The wireless communications system 200 may support transition of the UE 115-a (and, in some cases, the network entity 105-a) between multiple power states (e.g., N power states), where each power state of the multiple power states corresponds to a respective directional communication profile of the UE 115-a. The multiple power states may include, but are not limited to, an uplink-only power state (e.g., an uplink only-configured grant power state, an uplink only-dynamic grant power state), a downlink-only power state, a downlink semi-persistent scheduling (SPS) power state, an uplink-and-downlink power state (e.g., a normal power state), a modem off power state, a high-rate power state (e.g., a downlink high-rate power state, an uplink high-rate power state), a low-rate power state (e.g., a downlink low-rate power state, an uplink low-rate power state), or any combination thereof. For example, the multiple power states may include at least one power state that is associated with uplink communications (e.g., uplink-only communications), at least one power state that is associated with downlink communications (e.g., downlink-only communications), and at least one power state that is associated with both uplink and downlink communications. In some examples, the multiple power states may be associated with multiple CCs (e.g., according to one or more power state patterns).

For illustrative purposes, the multiple power states in the context of FIG. 2 may include a first power state 215, a second power state 220, and a third power state 225, each of which may be any power state or any combination of power states described herein. Although the wireless communications system 200 illustrates a configuration of three power states (e.g., the first power state 215, the second power state 220, and the third power state 225), it is to be understood that any wireless device or combination of wireless devices may be configured to cycle between any quantity or combination of power states.

Each directional communication profile may correspond to one or more communication parameters that configure the UE 115-a to communicate in a respective communication direction and according to a respective traffic profile. For example, each directional communication profile may indicate or otherwise be associated with a BWP for a primary cell, a dormant BWP for the primary cell, one or more BWPs for one or more secondary cells, a dormant BWP for the one or more secondary cells, or a combination thereof. Additionally, or alternatively, each directional communication profile may be associated with restricted reception of a data channel, a control channel, or both, in the BWP for the primary cell, the one or more BWPs for the one or more secondary cells, or some combination thereof.

Additionally, each power state and each directional communication profile may be associated with a configuration of the UE 115-a that enables the UE 115-a to operate according to one or more behaviors. As an illustrative example in the context of FIG. 2, the first power state 215 may be associated with a first directional communication profile and a first configuration of the UE 115-a, the second power state 220 may be associated with a second directional communication profile and a second configuration of the UE 115-a, and the third power state 225 may be associated with a third directional communication profile and a third configuration of the UE 115-a.

Moreover, each power state (e.g., each directional communication profile) may be associated with a power consumption (e.g., an expected power level consumption). For example, the first power state 215 may be associated with a first power consumption level, the second power state 220 may be associated with a second power consumption level, and the third power state 225 may be associated with a third power consumption level, where the first power consumption level is less than the second power consumption level and the second power consumption level is less than the third power consumption level.

In some examples, the first directional communication profile, the second directional communication profile, the third directional communication profile, or any combination thereof, may indicate restricted reception or transmission of a single type of data traffic or of multiple types of data traffic to flexibly allocate modem power states for the UE 115-a and to reduce power consumption by the UE 115-a. Thus, each directional communication profile may be tailored to an expected traffic environment (e.g., an amount of traffic, one or more traffic directions, a data rate, a throughput), or a lack thereof, at the UE 115-a, such that the UE 115-a is configured to perform the one or more behaviors.

For example, an uplink-only configured grant power state may be associated with a configuration of the UE 115-a in which the UE 115-a refrains from monitoring for downlink transmissions (e.g., via PDCCH and PDSCH), reduces a frequency of retransmissions (e.g., as compared to the uplink-and-downlink power state), may dormant one or more BWPs associated with additional cells (e.g., additional network entities 105) of the UE 115-a, and may perform uplink positioning. In another example, an uplink-only dynamic grant power state may be associated with a configuration of the UE 115-a in which the UE 115-a refrains from monitoring for downlink transmissions associated with scheduling downlink transmissions (e.g., downlink DCI messages) and may monitor a downlink control channel for downlink transmissions associated with scheduling uplink transmissions (e.g., uplink grants).

Additionally, or alternatively, a downlink-only power state may be associated with a configuration of the UE 115-a in which the UE 115-a monitors for downlink transmissions and refrains from transmitting uplink control messages (e.g., DCI messages). In some examples, the UE 115-a may transmit scheduling requests (e.g., conditional scheduling requests) while operating in the downlink-only power state. Additionally, or alternatively, a downlink SPS power state may be associated with a configuration of the UE 115-a in which the UE 115-a monitors for transmissions associated with an SPS configuration.

An uplink-and-downlink power state may be associated with a configuration of the UE 115-a in which the UE 115-a monitors for both uplink transmissions and downlink transmissions. Additionally, the uplink-and-downlink power state may be associated with relatively densely-configured communications, such as reference signals, wake-up signal (WUS) occasions, or other examples. A modem-off power state may be associated with a configuration of the UE 115-a in which the UE 115-a sleeps or idles, and in which SSSGs are configured to be empty, WUSs are deactivated, and the UE 115-a does not transmit or receive signals.

In the example of FIG. 2, the first power state 215 may be an example of a modem-off power state, the second power state 220 may be an example of an uplink-only power state, and the third power state 225 may be an example of an uplink-and-downlink power state. When a power state corresponds to a directional communication profile having restricted reception or transmission of a directional channel, the UE 115-a may reduce power consumption by turning off one or more modems (e.g., transmission or reception circuitry) that are not used by the UE 115-a for communications via the directional channel. While operating in the first power state 215, for instance, the UE 115-a may turn off multiple (e.g., all) modems. In some cases, the first power state 215 may correspond to an idle or sleep state. Thus, the UE 115-a may consume less power during operations in the first power state 215 than in the second power state 220 or the third power state 225.

As illustrated in FIG. 2, the second directional communication profile may correspond to reduced or restricted downlink data traffic at the UE 115-a. Thus, the second directional communication profile may indicate restricted reception of a downlink shared channel, a downlink control channel, or both. The UE 115-a may turn off one or more modems associated with downlink traffic reception while operating in the second power state 220 (e.g., an uplink-only power state). Alternatively, in other examples, the second directional profile may correspond to reduced or restricted uplink data traffic at the UE 115-a, and may indicate restricted transmission of an uplink shared channel, an uplink control channel, or both. In such examples, the UE 115-a may turn off one or more modems associated with uplink traffic transmission while operating in the second power state 220 (e.g., a downlink-only power state). In either example, based on restricted reception or transmission of one or more channels, the second power state 220 may provide for the UE 115-a to support one or more applications that are associated with relatively stringent QoS requirements, such as latency requirements (e.g., periodic low latency power constrained traffic (LLPCT), or traffic for other applications associated with relatively frequent transmission or low latency), while reducing power consumption at the UE 115-a.

The third directional communication profile may not correspond to restricted data traffic at the UE 115-a. Accordingly, while operating in the third power state 225, the UE 115-a may communicate via one or more downlink channels and one or more uplink channels. During operation in the third power state 225, the UE 115-a may refrain from turning off any modems. The third power state 225 and the third directional communication profile may thus be utilized for relatively high throughput at the UE 115-a, or for scenarios in which the UE 115-a is capable of supporting relatively high power consumption.

The network entity 105-a may configure the UE 115-a with the multiple power states (e.g., with the first power state 215, the second power state 220, and the third power state 225). For example, the network entity 105-a may indicate the multiple power states to the UE 115-a as part of control signaling (e.g., RRC signaling) via the communication link 125-a. The control signaling may indicate the multiple power states, one or more parameters (e.g., of an associated configuration of the UE 115-a) corresponding to each power state of the multiple power states, or some combination thereof. In some cases, the control message 205 may indicate the multiple power states and the RLF/BF detection and recovery configuration(s). Although the wireless communications system 200 illustrates a configuration of three power states (e.g., the first power state 215, the second power state 220, and the third power state 225), it is to be understood that the techniques described herein may be applied to any quantity or configuration of power states.

The UE 115-a may transition between power states to increase power savings, meet a QoS threshold for a given directional communication profile, or both. More specifically, the UE 115-a may transition between power states based on receiving downlink control messages (e.g., DCI, MAC-CE) from the network entity 105-a, based on satisfying one or more conditions, according to one or more schedules (e.g., power state transition schedules), or a combination thereof. In some examples, the one or more conditions may be satisfied based on the UE 115-a initiating a retransmission timer, transmitting a negative acknowledgment message for one or more downlink messages, operating in an activation period of a power state, receiving a burst of downlink messages, receiving a second control message indicating a power state, expiration of a timer, or any combination thereof.

For example, the UE 115-a may transition between power states based on receiving control signaling, such as a downlink control message (e.g., a DCI message), from the network entity 105-a that indicates a power state. For example, the UE 115-a may operate in the first power state 215. During operation in the first power state 215, the UE 115-a may receive a DCI message from the network entity 105-a that indicates the second power state 220. The UE 115-a may transition from the first power state 215 to the second power state 220 based on receiving the DCI message.

Additionally, or alternatively, each power state may correspond to a timer. The network entity 105-a may configure a respective timer for each power state of the multiple power states. In some cases, the network entity 105-a may indicate, to the UE 115-a, a set of timers corresponding to the multiple power states via control signaling (e.g., the UE 115-a may be RRC-configured with the timers for the multiple power states). In some examples, the network entity 105-a may dynamically adapt one or more timers of the set of timers according to a directional traffic periodicity (e.g., uplink traffic periodicity, downlink traffic periodicity) or to align with a beginning of an on duration (e.g., a connected mode discontinuous reception (CDRX) on duration). In other examples, the set of timers may be associated with SSSG skipping, but the UE 115-a may be configured to use the set of timers for the multiple power states (e.g., in addition to or instead of SSSG skipping). In any case, the UE 115-a may operate in a power state for a time duration of a timer corresponding to the power state. After expiry of the timer, the UE 115-a may transition to a different power state.

Alternatively, the UE 115-a may transition between power states at periodic times, e.g., according to a power state pattern, a periodic cycle, or a set of activation periods. For instance, each power state may be associated with one or more timers and one or more activation periods. The UE 115-a may transition from the first power state 215 to the second power state 220 based on the UE 115-a transitioning to an activation period associated with the second power state 220. The UE 115-a may initiate a first timer T1 associated with the activation period based on transitioning to the second power state 220 during the activation period. Additionally, the UE 115-a may transition from the second power state 220 to (e.g., back to) the first power state 215 based on expiration of the first timer T1. In some other examples, the UE 115-a may transition between power states based on activation periods or timers associated with each power state according to periodicity of uplink traffic, downlink traffic, or both.

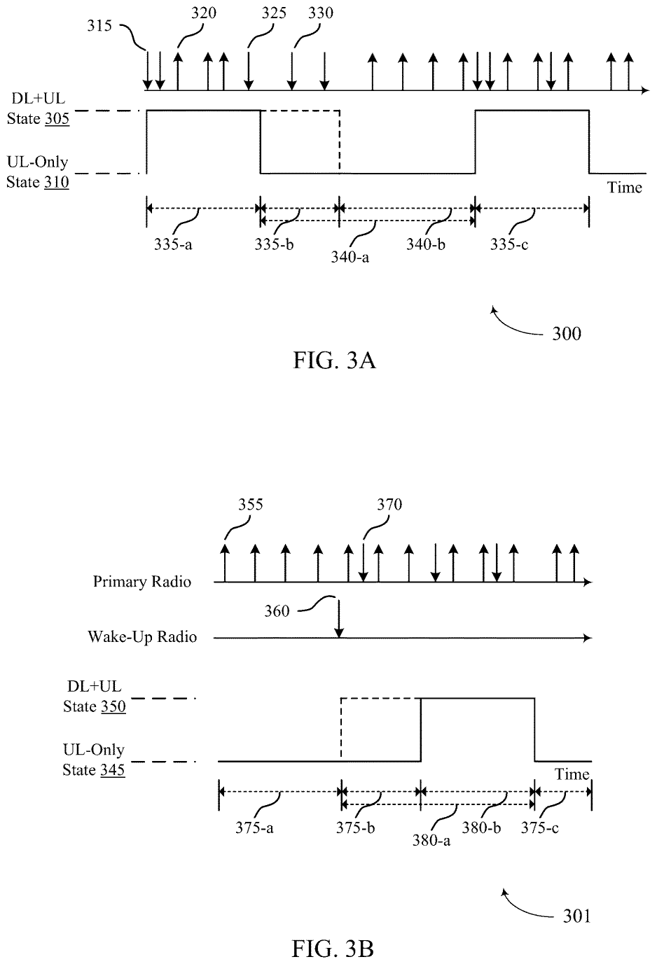

In yet another example, the UE 115-a may be configured with multiple schedules (e.g., power state transition schedules) for transitioning between power states. As described in more detail with reference to FIGS. 3A and 3B, a schedule for transitioning between power states may be understood as a timing pattern for a set of power states. That is, a schedule may include one or more time durations corresponding to one or more power states. The UE 115-a may apply a schedule to operate in each power state of the one or more power states for a respective time duration of the one or more time durations. Thus, the UE 115-a may transition between power states according to the schedule. In some cases, each time duration (and therefore each power state) of a schedule may be associated with or based on a timer, where the UE 115-a initiates the timer when the UE 115-a begins operating in the power state; the UE 115-a may transition to the second power state when the timer expires.

In a first set of power states (e.g., downlink-only power states, downlink-and-uplink power states) of the multiple power states, such as the third power state 225, the UE 115-a may be able to receive downlink reference signals and may therefore perform RLF/BF detection operations. In a second set of power states (e.g., uplink-only power states, modem-off power states) of the multiple power states different from the first set of power states, such as the first power state 215 or the second power state 220, the UE 115-a may be unable to receive downlink reference signals and therefore may not perform RLF/BF detection operations while operating in such power states. Thus, if RLF or BF occurs during operation in the first power state 215 or the second power state 220, the UE 115-a may be unable to recover or re-establish a connection with the network entity 105-a. Accordingly, the network entity 105-a and the UE 115-a may implement transitions between power states using timing (e.g., timing patterns, schedules) that supports RLF/BF detection and recovery operations. For example, the network entity 105-a may configure (e.g., RRC configure) the UE 115-a with a set of schedules indicated via control signaling, such as the control message 205. The UE 115-a may select and apply a schedule from the set of schedules based on whether the UE 115-a is to perform an RLF/BF detection operation. Additionally, or alternatively, the UE 115-a may apply a schedule from the set of schedules based on receiving an indication of the schedule from the network entity 105-a (e.g., via DCI, such as the DCI 207, or MAC-CE).

For example, some schedules for transitioning between power states may be configured to include relatively long durations for operating in a power state of the first set of power states, such as the third power state 225, and the UE 115-a may apply such a schedule before initiating an RLF/BF detection operation. Thus, the UE 115-a may have sufficient time to perform the RLF/BF detection operation prior to switching to a power state of the second set of power states, such as the second power state 220. As a result, the UE 115-a may avoid entering the second power state 220 with a relatively weak serving beam or radio link, which may improve communications reliability. Additionally, by ensuring that the UE 115-a is able to perform the RLF/BF detection operation before transitioning to the second power state 220, the UE 115-a may significantly decrease a likelihood that RLF or BF occurs during operation in the second power state 220.

Additionally, or alternatively, the UE 115-a may switch or otherwise apply schedules based on whether operation in a power state supports RLF/BF detection operations and based on whether an RLF/BF detection operation is to be performed by the UE 115-a. For example, the UE 115-a may operate according to a first schedule that includes a first time duration for operation in the third power state 225 and a second time duration for operation in the second power state 220. The UE 115-a may determine that the UE 115-a is to perform an RLF/BF detection operation, but may be configured to transition to the second power state 220 according to the first schedule. To perform the RLF/BF detection operation, the UE 115-a may switch to a second schedule. The second schedule may include a postponement of the transition to the second power state 220 such that the UE 115-a may perform the RLF/BF detection operation prior to transitioning to the second power state 220. In some examples, the second schedule may include a relatively long first time duration for operation in the third power state 225. Additionally, or alternatively, the second schedule may not include any power states that would prevent the UE 115-a from performing the RLF/BF detection operation. In some cases, the second schedule may indicate that the UE 115-a is to postpone transitioning to the second power state 220 until after expiry of a failure detection timer (e.g., a beam failure detection timer) of the RLF/BF detection operation.

In some examples, the UE 115-a may be triggered to apply the second schedule (e.g., triggered to postpone transitioning to the second power state 220) by the network entity 105-a. For example, the UE 115-a may apply the second schedule based on receiving an RLF/BF detection operation activation DCI (e.g., the DCI 207) from the network entity 105-a. That is, if the UE 115-a is instructed to begin an RLF/BF detection operation by the network entity 105-a, the UE 115-a may autonomously apply the second schedule to prevent transitioning to the second power state 220. In such examples, the UE 115-a may maintain the second schedule (e.g., may refrain from transitioning to the second power state 220) until a quality of the radio link or the serving beam improves (e.g., above a signal quality threshold) or until the failure detection timer expires.

Additionally, or alternatively, the RLF/BF detection operation activation DCI (e.g., the DCI 207) may include an indication that the UE 115-a is to apply the second schedule. More specifically, the network entity 105-a may multiplex the indication that the UE 115-a is to apply the second schedule with the DCI 207. For instance, if the network entity 105-a determines that a quality of the communication link 125-a or a serving beam associated with the communication link 125-a is poor or otherwise degrading, the network entity 105-a may transmit the DCI 207 to the UE 115-a to both postpone the UE 115-a's transition to the second power state 220 and to initiate the RLF/BF detection operation at the UE 115-a.

As another example, the network entity 105-a may transmit a WUS 210 to the UE 115-a to indicate that the UE 115-a is to apply the second schedule. In some cases, the WUS 210 may be associated with an indication that the UE 115-a is to perform the RLF/BF detection operation. The UE 115-a may apply the second schedule (e.g., may postpone the transition to the second power state 220) based on receiving the WUS 210 and may initiate the RLF/BF detection operation. In some cases, the WUS 210 may include an indication of the second schedule.

In some aspects, the second schedule may include a transition from a power state in which the UE 115-a is unable to perform the RLF/BF detection operation, such as the first power state 215 or the second power state 220, to a power state in which the UE 115-a may perform the RLF/BF detection operation, such as the third power state 225. During operation in the second power state 220, for example, a primary radio of the UE 115-a may operate in an uplink-only state, while a wake-up receiver of the UE 115-a may remain active and able to receive WUSs. The network entity 105-a may monitor the communication link 125-a and the serving beam. If the network entity 105-a determines that a quality of the communication link 125-a or the serving beam degrades and falls below a signal quality threshold, the network entity 105-a may transmit the WUS 210 to the UE 115-a to initiate the RLF/BF detection operation at the UE 115-a. The wake-up receiver of the UE 115-a may trigger the primary radio to transition to the third power state 225 for the UE 115-a to perform the RLF/BF detection operation.

Alternatively, the UE 115-a may autonomously determine whether to apply a schedule, for example, based on whether the UE 115-a determines to perform an RLF/BF detection operation. In some cases, the UE 115-a may select a schedule from the set of schedules based on a configured priority associated with the RLF/BF detection operation. Here, the control message 205 may additionally indicate a priority (e.g., high, medium, low) for the beam failure detection timer (e.g., BeamFailureDetectionTimer) as part of the RLF or BF monitoring configuration(s). Each schedule of the set of schedules may be associated with a respective timer duration for postponing a transition to the second power state 220. The UE 115-a may select the schedule from the set of schedules based on an association (e.g., a mapping) between the respective timer durations and the indicated priority of the beam failure detection timer. A higher priority may be associated with a relatively long timer duration, such that the UE 115-a is provided sufficient time to perform the RLF/BF detection operation before transitioning to the second power state 220. Thus, if the beam failure detection timer is configured with a “high” priority, the UE 115-a may select a schedule that includes a relatively long timer duration. Alternatively, a lower priority may correspond to a relatively short timer duration. If the beam failure detection timer is associated with a “low” priority, the UE 115-a may select a schedule that enables the UE 115-a to transition to the second power state 220 more quickly (e.g., a schedule that has a short timer duration).

In some examples, the UE 115-a may select or apply a schedule based on detecting a BFI, e.g., during the RLF/BF detection operation. For instance, the UE 115-a may perform the RLF/BF detection operation while operating in the third power state 225 and according to a first schedule that includes a transition to the second power state 220. If the UE 115-a detects at least one BFI during the RLF/BF detection operation, the UE 115-a may postpone the transition to the second power state 220 by applying the second schedule. In some cases, the UE 115-a may postpone the transition until after expiry of a failure detection timer associated with the RLF/BF detection operation. If the failure detection timer expires, or if the UE 115-a no longer detects any BFIs, the UE 115-a may transition to the second power state 220.

The UE 115-a may transmit the uplink message 212 to the network entity 105-a to indicate that the UE 115-a has applied the second schedule (e.g., to indicate that the UE 115-a has postponed the transition to the second power state 220). The indication may include or be an example of a set of bits of the uplink message 212. In some cases, the uplink message 212 may include or be an example of an uplink control message (UCI) or a MAC-CE. In other cases, the uplink message 212 may include or be an example of a data message, such as a PUSCH, and the UE 115-a may piggyback the indication that the second schedule is applied (e.g., the set of bits) to the data message. Based on receiving the uplink message 212, the network entity 105-a may transmit one or more downlink reference signals to the UE 115-a for the UE 115-a to use for performing the RLF/BF detection operation.

In some cases, the UE 115-a and the network entity 105-a may additionally modify or otherwise adjust a HARQ RTT timer (e.g., drx-HARQ-RTT-TimerUL) based on a power state in which the UE 115-a operates. The UE 115-a may initiate the HARQ RTT timer upon transmitting an uplink message, such as the uplink message 212, to the network entity 105-a. The HARQ RTT timer may define a minimum time duration between transmission of the uplink message 212 and receipt of a retransmission grant for the uplink message 212 (e.g., a retransmission grant pertaining to retransmission, by the UE 115-a, of the uplink message 212). If the HARQ RTT timer expires before the UE 115-a receives, from the network entity 105-a, feedback information (e.g., HARQ feedback information, such as a positive acknowledgement (ACK) or a negative acknowledgment (NACK)) relating to the uplink message 212, the UE 115-a may assume that the network entity 105-a failed to receive the uplink message 212. Accordingly, the UE 115-a may begin monitoring for the retransmission grant for the uplink message 212.

In a first example, when the UE 115-a operates in a downlink-only power state, the UE 115-a may be unable to transmit a retransmission of the uplink message 212. Thus, the UE 115-a and the network entity 105-a may pause the HARQ RTT timer based on the UE 115-a operating in the downlink-only power state. In a second example, when the UE 115-a operates in an uplink-only power state (e.g., the second power state 220), the UE 115-a may enable HARQ Mode B, in which retransmissions (e.g., of the uplink message 212) are deactivated. Thus, the UE 115-a may refrain from initiating the HARQ RTT timer based on the HARQ Mode B. If the UE 115-a transitions from the uplink-only power state to a downlink-only power state or a downlink-and-uplink power state, the UE 115-a may initiate the HARQ RTT timer. In a third example, the UE 115-a may pause the HARQ RTT timer during the uplink-only power state, as the UE 115-a may not receive downlink transmissions and may therefore be unable to monitor for the retransmission grant for the uplink message 212. During operation in the downlink-only power state, the UE 115-a may resume the HARQ RTT timer and may monitor for the retransmission grant.

FIGS. 3A and 3B show examples of communication timelines 300 and 301 that support failure detection for communication power state switching in accordance with one or more aspects of the present disclosure. The communication timelines 300 and 301 may implement various aspects of the present disclosure described with reference to FIGS. 1 and 2. For example, the communication timelines 300 and 301 may illustrate timing patterns for communications by a UE and a network entity, which may be examples of corresponding devices as described herein. The UE and the network entity may communicate via a communication link (e.g., a radio link) using one or more beams. The UE may be configured with multiple power states including at least a downlink-and-uplink power state 305 and an uplink-only power state 310, which may be examples of a downlink-and-uplink power state and an uplink-only power state as described with reference to FIG. 2. The UE may transition between the downlink-and-uplink power state 305 and the uplink-only power state 310 according to one or more schedules and based on whether the UE is to perform an RLF/BF detection operation.

The communication timelines 300 and 301 illustrate uplink and downlink traffic between the UE and the network entity over time, as the UE transitions between the downlink-and-uplink power state 305 and the uplink-only power state 310 according to a first schedule and a second schedule. Although the communication timelines 300 and 301 are described with reference to switching between the downlink-and-uplink power state 305 and the uplink-only power state 310, it is to be understood that the communication timelines 300 and 301 illustrated in FIGS. 3A and 3B may correspond to any combination of power states. For example, the timing illustrated by the communication timelines 300 and 301 may be applied to any quantity and combination of power states and schedules as discussed herein.

In the communication timeline 300 illustrated in FIG. 3A, the UE may initially operate in the downlink-and-uplink power state 305. In the downlink-and-uplink power state 305, the UE may be capable of receiving downlink traffic (e.g., a downlink control signal 315, a downlink signal 325, a downlink reference signal 330) and transmitting uplink traffic (e.g., an uplink message 320). For example, the UE may receive a downlink control signal 315, such as an RRC message, that includes control information. The control information may indicate the first schedule for the UE to transition between the downlink-and-uplink power state 305 and the uplink-only power state 310. The first schedule may include a first set of time durations during which the UE is to operate in the downlink-and-uplink power state 305, such as a time duration 335-a and a time duration 335-c. The first schedule may also include a second set of time durations during which the UE is to operate in the uplink-only power state 310, such as a time duration 340-a. In some cases, the UE may maintain a respective timer for each time duration (e.g., each time duration 335, each time duration 340) and may transition between power states at expiry of the respective timers.

When operating according to the first schedule, the UE may transition from the downlink-and-uplink power state 305 to the uplink-only power state 310 at the end of the time duration 335-a, and may operate in the uplink-only power state 310 for the time duration 340-a. In the uplink-only power state 310, the UE may refrain from monitoring for downlink traffic, but may be capable of transmitting uplink traffic. Thus, in the uplink-only power state 310, the UE may be unable to receive downlink reference signals, such as the downlink reference signal 330, used in an RLF/BF detection operation. If a quality of the communication link or a beam (e.g., a serving beam) of the one or more beams degrades or fails, the UE may not be able to perform RLF/BF detection and recovery while operating in the uplink-only power state 310. As such, if the UE determines that the UE is to perform an RLF/BF detection operation, the UE may postpone the transition to the uplink-only power state 310 by applying the second schedule.

Applying the second schedule may enable the UE to perform the RLF/BF detection operation prior to transitioning to the uplink-only power state. In some cases, the UE may apply the second schedule autonomously, e.g., without instruction from the network entity. For instance, the UE may apply the second schedule based on the determination that the UE is to perform the RLF/BF detection operation, or based on detecting at least one BFI during the RLF/BF detection operation. In other cases, the UE may apply the second schedule based on receiving an indication from the network entity. As an example, the UE may receive the downlink signal 325 including an indication that the UE is to apply the second schedule. Additionally, or alternatively, the downlink signal 325 may be an example of an activation DCI for the RLF/BF detection operation, and the UE may apply the second schedule based on receiving the activation DCI. In another example, the downlink signal 325 may be an example of a WUS that is associated with an indication that the UE is to perform the RLF/BF detection operation, and the UE may apply the second schedule based on receiving the WUS. In some cases, the downlink signal 325 may include an indication of the second schedule.

The second schedule may be different from the first schedule, in that the second schedule may have different time durations for operations in each of the downlink-and-uplink power state 305 and the uplink-only power state 310. For example, the second schedule may include a postponement of the transition to the uplink-only power state 310 by a time duration 335-b. The UE may remain in the downlink-and-uplink power state 305 for the time duration 335-b, in which the UE may perform the RLF/BF detection operation. During the RLF/BF detection operation and based on operating in the downlink-and-uplink power state 305, the UE may receive one or more downlink reference signals, such as the downlink reference signal 330, for use in the RLF/BF detection operation.

The UE may transition, in accordance with the second schedule, to the uplink-only power state 310 after the time duration 335-b, and may operate in the uplink-only power state for the time duration 340-b as indicated by the second schedule. In some examples, the time duration 335-b may be a time duration of a failure detection timer associated with the RLF/BF detection operation. Here, the UE may initiate the failure detection timer during the RLF/BF detection operation (e.g., after detecting a BFI), and may refrain from transitioning to the uplink-only power state 310 until the failure detection timer expires. If the UE detects a BFI during the failure detection timer (e.g., within the time duration 335-b), the UE may restart the failure detection timer, and may not transition to the uplink-only power state until the failure detection timer has expired without detecting any BFIs.

Additionally, or alternatively, the time duration 335-b may correspond to a duration of time for the UE to perform the RLF/BF detection operation. That is, an end time of the time duration 335-b may correspond to time at which the RLF/BF detection operation is completed by the UE, such that the UE transitions to the uplink-only power state 310 after performing the RLF/BF detection operation.

In some examples, the time duration 335-b (e.g., the time duration for which the transition to the uplink-only power state 310 is postponed) may differ based on a priority of the failure detection timer. For instance, the UE may be configured with multiple schedules including at least the first schedule and the second schedule, where each schedule of the multiple schedules may correspond to a respective timer duration for postponement of the transition to the uplink-only power state 310. Each timer duration, and thus each schedule, may be associated with a respective priority of the RLF/BF detection operation. The UE may receive a priority indication associated with the RLF/BF detection operation (e.g., associated with the failure detection timer) and may select a schedule from the set of schedules based on the priority indication. A higher priority may be associated with a longer timer duration prior to transitioning to the uplink-only power state 310, while a lower priority may be associated with a shorter timer duration prior to transitioning to the uplink-only power state 310. Thus, the time duration 335-b may correspond to the timer duration of the schedule selected by the UE based on the priority indication.

FIG. 3B illustrates the communication timeline 301, in which the UE may transition from an uplink-only power state 345 to a downlink-and-uplink power state 350 according to a first schedule and a second schedule. The first schedule may include a time duration 375-a and a time duration 375-c in which the UE operates in the uplink-only power state 345. During operation in the uplink-only power state 345, a primary radio of the UE may transmit uplink messages 355 (e.g., may not receive downlink transmissions), while a wake-up radio of the UE may monitor for a WUS 360 from the network entity. Additionally, the first schedule may include a time duration 380-b in which the UE operates in the downlink-and-uplink power state 350. In the downlink-and-uplink power state 350, the primary radio may be used for uplink and downlink transmissions.

In the example of FIG. 3B, the UE may be triggered to apply the second schedule and to perform an RLF/BF detection operation based on receiving the WUS 360. While the UE is in the uplink-only power state 345 (e.g., during the time duration 375-a) and is unable to use the primary radio to receive downlink reference signals via the communication link with the network entity, the network entity may monitor a quality of the communication link and the one or more beams. If the network entity determines that the UE is to perform an RLF/BF detection operation, the network entity may transmit the WUS 360 to the UE to transition the UE to the downlink-and-uplink power state 350. The wake-up radio of the UE may receive the WUS 360 and may trigger the primary radio of the UE to wake up, e.g., to transition to the downlink-and-uplink power state 350 in order to perform the RLF/BF detection operation.

In some examples, the UE may be configured with a time interval between reception of the WUS 360 and the transition to the downlink-and-uplink power state 350. For instance, the UE may receive control signaling, such as RRC signaling, a MAC-CE, or the like, that indicates the time interval. When the wake-up radio of the UE receives the WUS 360, the wake-up radio may trigger the primary radio of the UE to transition to the downlink-and-uplink power state 350 after the time interval.

Based on receiving the WUS 360, the UE may apply the second schedule, switch to the downlink-and-uplink power state 350, and perform the RLF/BF detection operation. In some cases, the WUS 360 may include an indication of the second schedule. In the second schedule, the transition from the uplink-only power state 345 to the downlink-and-uplink power state 350 may occur prior to a transition from the uplink-only power state 345 to the downlink-and-uplink power state 350 of the first schedule. That is, by applying the second schedule, the UE may transition to the downlink-and-uplink power state 350 by a time duration 375-b sooner than if the UE operated according to the first schedule. After transitioning to the downlink-and-uplink power state 350, the UE may receive a downlink reference signal 370 from the network entity and may perform the RLF/BF detection operation using the downlink reference signal 370.

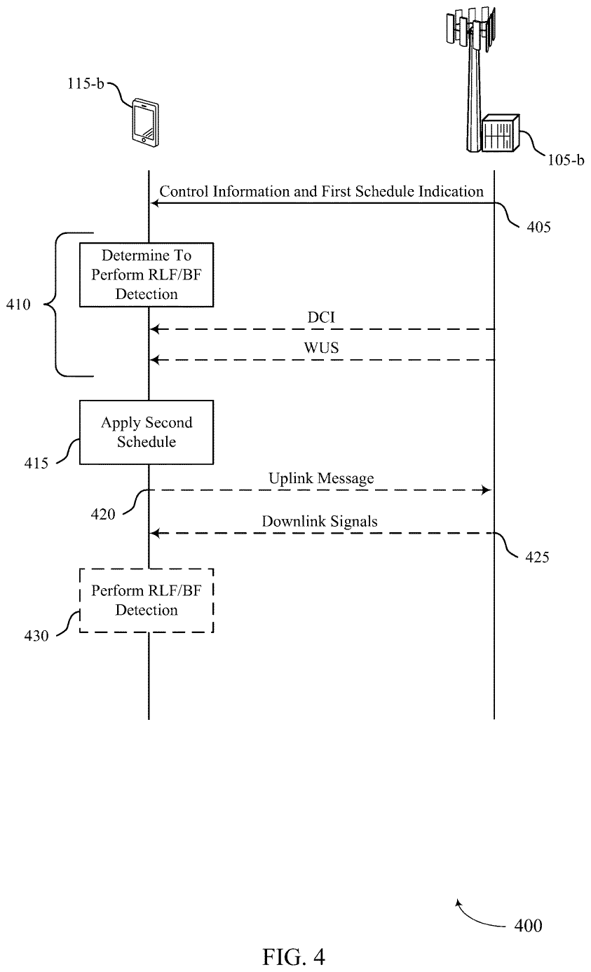

FIG. 4 shows an example of a process flow 400 that supports failure detection for communication power state switching in accordance with one or more aspects of the present disclosure. In some examples, the process flow 400 may implement or be implemented by aspects of the wireless communications system 100 or the wireless communications system 200. For example, the process flow 400 may include one or more network entities 105 (e.g., a network entity 105-b) and one or more UEs 115 (e.g., a UE 115-b), which may be examples of the corresponding devices as described with reference to FIG. 1.

The process flow 400 may support the UE 115-b and the network entity 105-b transitioning between power states of a set of power states according to one or more schedules based on performing an RLF/BF detection procedure. The power states may include at least an uplink-only power state in which the UE 115-b may transmit uplink transmissions (e.g., and may not receive downlink transmissions) and a second state in which the UE 115-b may receive downlink transmissions. For example, the second state may include or be an example of a downlink-only power state or a downlink-and-uplink power state, among other examples.

At 405, the network entity 105-b may transmit, and the UE 115-b may receive, control information that indicates a first schedule for the UE 115-b to transition between the set of power states. The first schedule may include at least a first time duration for the UE 115-b to operate in the uplink-only power state and a second time duration for the UE 115-b to operate in the second power state. In some cases, the control information may additionally indicate a set of schedules for the UE 115-b to transition between the set of power states, where the set of schedules includes at least the first schedule and a second schedule. The second schedule may include a postponement of a transition from the second power state to the uplink-only power state.

At 410, the UE 115-b may determine that the UE 115-b is to perform an RLF/BF detection operation. In some cases, the UE 115-b may determine to perform the RLF/BF detection operation based on receiving a DCI at 410. In such cases, the network entity 105-b may transmit, and the UE 115-b may receive, the DCI, which may activate the RLF/BF detection operation (e.g., the DCI may be an activation DCI for an RLF/BF detection operation). For example, the DCI may include an indication that the RLF/BF detection operation is activated, and the UE 115-b may begin the RLF/BF detection operation based on receiving the DCI. In some examples, the DCI may further indicate that the UE 115-b is to apply the second schedule for transitioning between power states.

Additionally, or alternatively, the UE 115-b may determine to perform the RLF/BF detection operation based on receiving a WUS at 410. For example, the WUS may be associated with an indication that the UE 115-b is to perform the RLF/BF detection operation, such that receiving the WUS triggers the UE 115-b to perform the RLF/BF detection operation. In some cases, the WUS may include an indication of the second schedule.

At 415, the UE 115-b may apply the second schedule for the UE 115-b to transition between the power states, for example, based on determining, at 410, that the UE is to perform the RLF detection operation or the BF detection operation. In some examples, the UE 115-b may apply the second schedule based on receiving the DCI at 410. For example, reception of the DCI at the UE 115-b may trigger the UE 115-b to apply the second schedule, or the DCI may include an indication that the UE 115-b is to apply the second schedule. In other examples, the UE 115-b may apply the second schedule based on receiving the WUS at 410. In such cases, the UE 115-b may additionally receive, from the network entity 105-b, an indication of a duration of time from receipt of the WUS to the transition from the uplink-only state to the second state.

In some examples, at 415, the UE 115-b may apply the second schedule based on selecting the second schedule from the set of schedules. Each schedule of the set of schedules may include a respective timer duration for postponing the transition from the second state to the uplink-only state. The UE 115-b may receive an indication of a priority associated with the RLF/BF detection operation and may select the second schedule based on the priority, e.g., based on an association between the respective timer duration of the second schedule and the indication of the priority. For instance, if the priority is indicated to be high, the UE 115-b may select the second schedule based on the second schedule having a relatively long timer duration. Alternatively, if the priority is indicated to be low, the UE 115-b may select the second schedule based on the second schedule having a relatively short timer duration.

At 420, the UE 115-b may optionally transmit, and the network entity 105-b may receive, an uplink message including an indication that the second schedule is applied. The uplink message may include or be an example of a UCI message, a MAC-CE, or a PUSCH message to which the indication is applied.

At 425, the network entity 105-b may transmit, and the UE 115-b may receive, one or more downlink signals for the UE 115-b to use in the RLF/BF detection operation, e.g., based on receiving the uplink message at 420.

At 430, the UE 115-b may perform the RLF/BF detection operation. In some examples, the UE 115-b may perform the RLF/BF detection operation after applying the second schedule. If the second schedule includes the postponement of the transition from the second state to the uplink-only state, applying the second schedule at 415 may include the UE 115-b remaining in the second state to perform the RLF/BF detection operation. In some cases, the postponement of the transition from the second state to the uplink-only state included in the second schedule may be configured to occur after expiry of a failure detection timer associated with the RLF/BF detection operation. The UE 115-b may initiate the failure detection timer during the RLF/BF detection operation and may transition to the uplink-only state if no BFIs are detected prior to expiration of the failure detection timer. In some cases, the second schedule may include the transition to the uplink-only state after completion of the RLF/BF detection operation.

In other examples, the UE 115-b may perform the RLF/BF detection operation prior to applying the second schedule. For instance, the UE 115-b may detect at least one BFI during the RLF/BF detection operation and may apply the second schedule based on detecting the BFI. In some cases, the UE 115-b may select the second schedule from the set of schedules based on detecting the BFI.

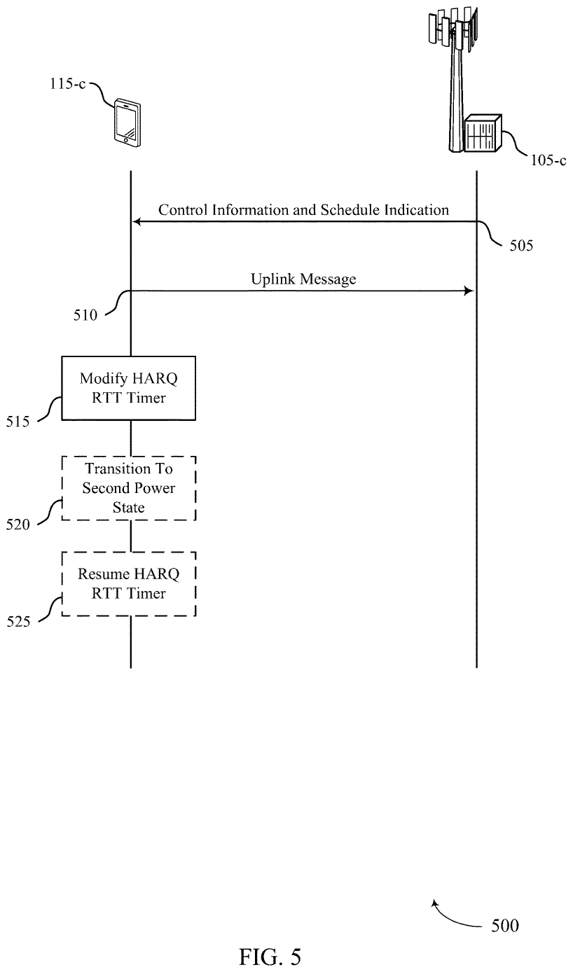

FIG. 5 shows an example of a process flow 500 that supports failure detection for communication power state switching in accordance with one or more aspects of the present disclosure. In some examples, the process flow 500 may implement or be implemented by aspects of the wireless communications system 100 or the wireless communications system 200. For example, the process flow 500 may include one or more network entities 105 (e.g., a network entity 105-c) and one or more UEs 115 (e.g., a UE 115-c), which may be examples of the corresponding devices as described with reference to FIG. 1.

The process flow 500 may support the UE 115-c and the network entity 105-c transitioning between a set of power states according to one or more schedules based on performing an RLF/BF detection operation. The set of power states may include at least an uplink-only power state in which the UE 115-c may transmit uplink transmissions (e.g., and may not receive downlink transmissions), a downlink-only power state in which the UE 115-c may receive downlink transmissions (e.g., and may not transmit uplink transmissions), and a downlink-and-uplink power state in which the UE 115-c may both transmit uplink transmissions and receive downlink transmissions.

At 505, the network entity 105-c may transmit, and the UE 115-c may receive, control information that indicates a schedule for the UE 115-c to transition between the set of power states.

At 510, the UE 115-c may operate in a first power state of the set of power states. The UE 115-c may transmit, and the network entity 105-c may receive, an uplink message, such as an uplink data message (e.g., PUSCH), an uplink control message (e.g., PUCCH), or the like.

Based on transmitting the uplink message, the UE 115-c may initiate a HARQ RTT timer that defines a minimum time duration between transmission of the uplink message and reception of a retransmission grant for retransmission (e.g., by the UE 115-c) of the uplink message. At 515, the UE 115-c may modify the HARQ RTT timer based on operating in the first power state. The modification of the HARQ RTT timer may include pausing the HARQ RTT timer (e.g., pausing decrement of the HARQ RTT timer), initiating the HARQ RTT timer, or refraining from initiating the HARQ RTT timer. Additionally, the modification may be based on the first power state, e.g., based on whether the first power state is the uplink-only power state, the downlink-only power state, or the downlink-and-uplink power state.

In a first example, at 515, the UE 115-c may pause the HARQ RTT timer when the first power state is the downlink-only power state, e.g., as the UE 115-c may be unable to transmit a retransmission of the uplink message during operation in the downlink-only power state. In a second example, the first power state may be the uplink-only power state and the UE 115-c may enable a HARQ mode B, in which retransmissions by the UE 115-c are deactivated. Thus, at 515, the UE 115-b may refrain from initiating the HARQ RTT timer, e.g., based on the retransmissions being deactivated. In a third example, if the first power state is the downlink-only power state or the downlink-and-uplink power state, the UE 115-c may initiate the HARQ RTT timer at 515.

In a fourth example, the first power state may be the uplink-only power state. At 515, the UE 115-c may pause the HARQ RTT timer based on the first power state being the uplink-only power state.

In this example, at 520, the UE 115-c may transition to a second power state of the set of power states. The second power state may be the downlink-only power state or the downlink-and-uplink power state. The UE 115-c may resume the HARQ RTT timer after transitioning to the second power state, e.g., based on the second power state being the downlink-only state or the downlink-and-uplink power state.

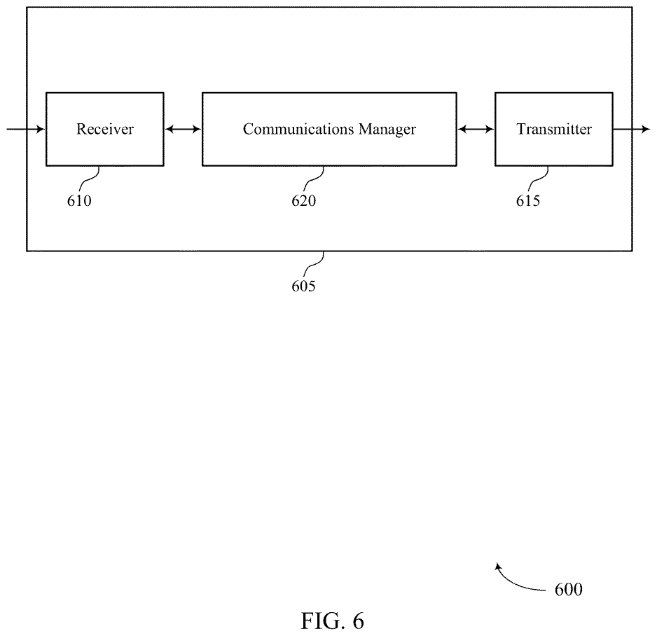

FIG. 6 shows a block diagram 600 of a device 605 that supports failure detection for communication power state switching in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques.

Each of these components may be in communication with one another (e.g., via one or more buses).

The receiver 610 may provide a means for receiving information such as packets, user data, control information, or any combination thereof associated with various information channels (e.g., control channels, data channels, information channels related to failure detection for communication power state switching).

Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to failure detection for communication power state switching). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of failure detection for communication power state switching as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication by a UE in accordance with examples as disclosed herein. For example, the communications manager 620 is capable of, configured to, or operable to support a means for receiving control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The communications manager 620 is capable of, configured to, or operable to support a means for determining that the UE is to perform an RLF or BF detection operation. The communications manager 620 is capable of, configured to, or operable to support a means for applying a second schedule for the UE to transition between the set of multiple power states based on the determination that the UE is to perform the RLF or BF detection operation.

Additionally, or alternatively, the communications manager 620 may support wireless communication by a UE in accordance with examples as disclosed herein. For example, the communications manager 620 is capable of, configured to, or operable to support a means for receiving control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions. The communications manager 620 is capable of, configured to, or operable to support a means for transmitting an uplink message. The communications manager 620 is capable of, configured to, or operable to support a means for modifying operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and reduced power consumption. For example, by configuring the device 605 with one or more schedules for transitioning between multiple power states, the device 605 may be capable of adaptively operating according to tradeoffs between power consumption and performance, which may reduce processing, reduce latency, and conserve battery while increasing reliability.

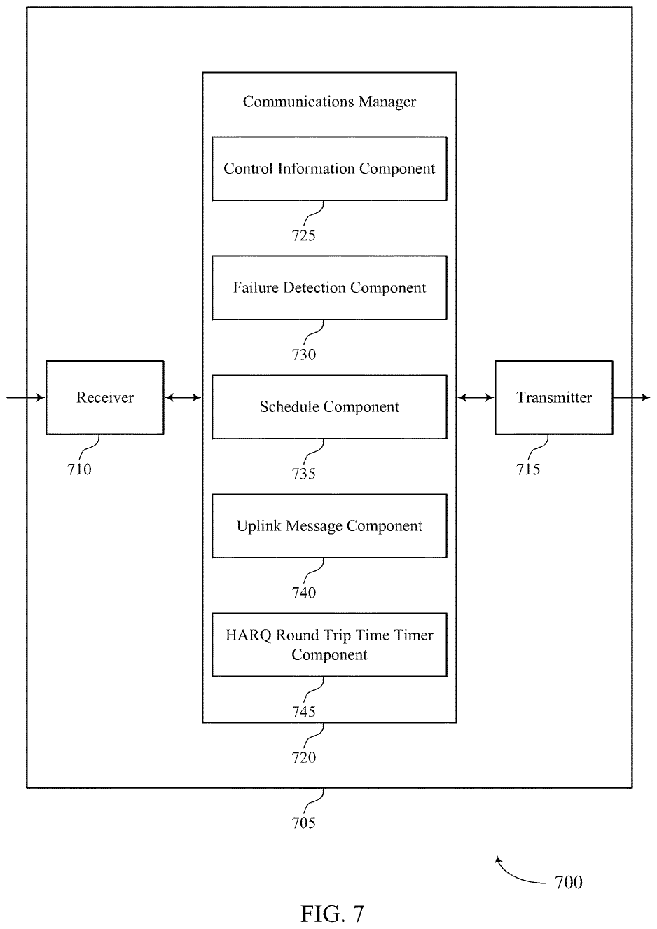

FIG. 7 shows a block diagram 700 of a device 705 that supports failure detection for communication power state switching in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to failure detection for communication power state switching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to failure detection for communication power state switching). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of failure detection for communication power state switching as described herein. For example, the communications manager 720 may include a control information component 725, a failure detection component 730, a schedule component 735, an uplink message component 740, a HARQ RTT timer component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication by a UE in accordance with examples as disclosed herein. The control information component 725 is capable of, configured to, or operable to support a means for receiving control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The failure detection component 730 is capable of, configured to, or operable to support a means for determining that the UE is to perform an RLF or BF detection operation. The schedule component 735 is capable of, configured to, or operable to support a means for applying a second schedule for the UE to transition between the set of multiple power states based on the determination that the UE is to perform the RLF or BF detection operation.

Additionally, or alternatively, the communications manager 720 may support wireless communication by a UE in accordance with examples as disclosed herein. The control information component 725 is capable of, configured to, or operable to support a means for receiving control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions. The uplink message component 740 is capable of, configured to, or operable to support a means for transmitting an uplink message. The HARQ RTT timer component 745 is capable of, configured to, or operable to support a means for modifying operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

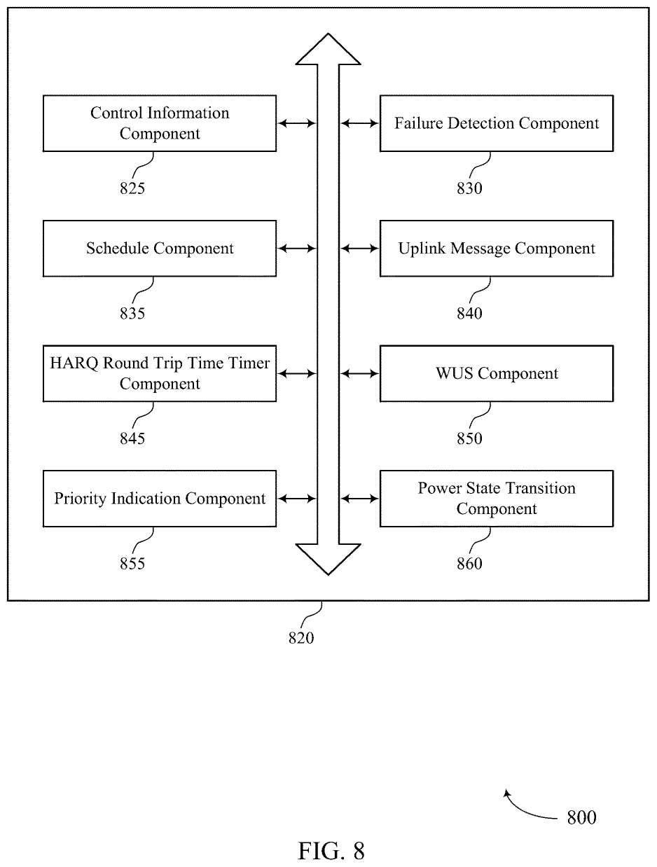

FIG. 8 shows a block diagram 800 of a communications manager 820 that supports failure detection for communication power state switching in accordance with one or more aspects of the present disclosure. The communications manager 820 may be an example of aspects of a communications manager 620, a communications manager 720, or both, as described herein. The communications manager 820, or various components thereof, may be an example of means for performing various aspects of failure detection for communication power state switching as described herein. For example, the communications manager 820 may include a control information component 825, a failure detection component 830, a schedule component 835, an uplink message component 840, a HARQ RTT timer component 845, a WUS component 850, a priority indication component 855, a power state transition component 860, or any combination thereof. Each of these components, or components or subcomponents thereof (e.g., one or more processors, one or more memories), may communicate, directly or indirectly, with one another (e.g., via one or more buses).

The communications manager 820 may support wireless communication by a UE in accordance with examples as disclosed herein. The control information component 825 is capable of, configured to, or operable to support a means for receiving control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The failure detection component 830 is capable of, configured to, or operable to support a means for determining that the UE is to perform an RLF or BF detection operation. The schedule component 835 is capable of, configured to, or operable to support a means for applying a second schedule for the UE to transition between the set of multiple power states based on the determination that the UE is to perform the RLF or BF detection operation.

In some examples, to support determining that the UE is to perform the RLF or BF detection operation, the control information component 825 is capable of, configured to, or operable to support a means for receiving a DCI message that activates the RLF or BF detection operation, where applying the second schedule is based on receipt of the DCI message.

In some examples, the second schedule includes a postponement of a transition from the second state to the uplink-only state until after an expiration of a failure detection timer associated with the RLF or BF detection operation.

In some examples, to support receiving the DCI message, the control information component 825 is capable of, configured to, or operable to support a means for receiving an indication that the UE is to apply the second schedule.

In some examples, to support determining that the UE is to perform the RLF or BF detection operation, the WUS component 850 is capable of, configured to, or operable to support a means for receiving a WUS associated with an indication that the UE is to perform the RLF or BF detection operation, where applying the second schedule is based on receipt of the WUS, and where the second schedule includes a postponement of a transition from the second state to the uplink-only state. In some examples, to support determining that the UE is to perform the RLF or BF detection operation, the failure detection component 830 is capable of, configured to, or operable to support a means for performing the RLF or BF detection operation after applying the second schedule. In some examples, the WUS includes an indication of the second schedule. In some examples, the second schedule includes a transition to the uplink-only state after completion of the RLF or BF detection operation.

In some examples, the control information further indicates a set of multiple schedules for the UE to transition between the set of multiple power states, and the priority indication component 855 is capable of, configured to, or operable to support a means for receiving a priority indication associated with the RLF or BF detection operation. In some examples, the control information further indicates a set of multiple schedules for the UE to transition between the set of multiple power states, and the schedule component 835 is capable of, configured to, or operable to support a means for selecting the second schedule from the set of multiple schedules based on the priority indication of the RLF or BF detection operation.

In some examples, to support selecting the second schedule from the set of multiple schedules, the schedule component 835 is capable of, configured to, or operable to support a means for selecting the second schedule based on an association between the respective timer duration of the second schedule and the priority indication. In some examples, the association includes that a higher priority is associated with a longer timer duration prior to a transition from the second state to the uplink-only state and a lower priority is associated with a shorter timer duration prior to the transition from the second state to the uplink-only state.

In some examples, to support determining that the UE is to perform the RLF or BF detection operation, the WUS component 850 is capable of, configured to, or operable to support a means for receiving a WUS associated with an indication that the UE is to perform the RLF or BF detection operation, where applying the second schedule is based on receipt of the WUS, and where the second schedule includes a transition from the uplink-only state to the second state. In some examples, the schedule component 835 is capable of, configured to, or operable to support a means for receiving an indication of a duration of time from receipt of the WUS and the transition from the uplink-only state to the second state.

In some examples, the failure detection component 830 is capable of, configured to, or operable to support a means for performing the RLF or BF detection operation. In some examples, the failure detection component 830 is capable of, configured to, or operable to support a means for detecting at least one failure instance during the RLF or BF detection operation, where applying the second schedule is based on detecting the at least one failure instance, and where the second schedule includes a postponement of a transition from the second state to the uplink-only state.

In some examples, the postponement of the transition from the second state to the uplink-only state is until after an expiration of a failure detection timer associated with the RLF or BF detection operation.

In some examples, the control information further indicates a set of multiple schedules for the UE to transition between the set of multiple power states, and the schedule component 835 is capable of, configured to, or operable to support a means for selecting the second schedule from the set of multiple schedules based on detecting the at least one failure instance.

In some examples, the schedule component 835 is capable of, configured to, or operable to support a means for transmitting an uplink message including an indication that the second schedule is applied. In some examples, the failure detection component 830 is capable of, configured to, or operable to support a means for receiving, based on transmitting the uplink message, one or more downlink signals for performing the RLF or BF detection operation, where the uplink message is one of an uplink control information message, a medium access control (MAC) control element (CE), or a PUSCH message to which the indication is piggybacked.

Additionally, or alternatively, the communications manager 820 may support wireless communication by a UE in accordance with examples as disclosed herein. In some examples, the control information component 825 is capable of, configured to, or operable to support a means for receiving control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions. The uplink message component 840 is capable of, configured to, or operable to support a means for transmitting an uplink message. The HARQ RTT timer component 845 is capable of, configured to, or operable to support a means for modifying operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

In some examples, to support modifying operation of the HARQ RTT timer, the HARQ RTT timer component 845 is capable of, configured to, or operable to support a means for pausing the HARQ RTT timer based on the first state being the downlink-only state.

In some examples, to support modifying operation of the HARQ RTT timer, the HARQ RTT timer component 845 is capable of, configured to, or operable to support a means for refraining from initiating the HARQ RTT timer based on the first state being the uplink-only state.

In some examples, to support modifying operation of the HARQ RTT timer, the HARQ RTT timer component 845 is capable of, configured to, or operable to support a means for initiating the HARQ RTT timer based on the first state being the downlink-only state or the downlink and uplink state.

In some examples, to support modifying operation of the HARQ RTT timer, the HARQ RTT timer component 845 is capable of, configured to, or operable to support a means for pausing the HARQ RTT timer based on the first state being the uplink-only state.

In some examples, the power state transition component 860 is capable of, configured to, or operable to support a means for transitioning to a second state of the set of multiple power states, the second state being one of the downlink-only state or the downlink and uplink state. In some examples, the HARQ RTT timer component 845 is capable of, configured to, or operable to support a means for resuming the HARQ RTT timer based on the second state being the downlink-only state or the downlink and uplink state.

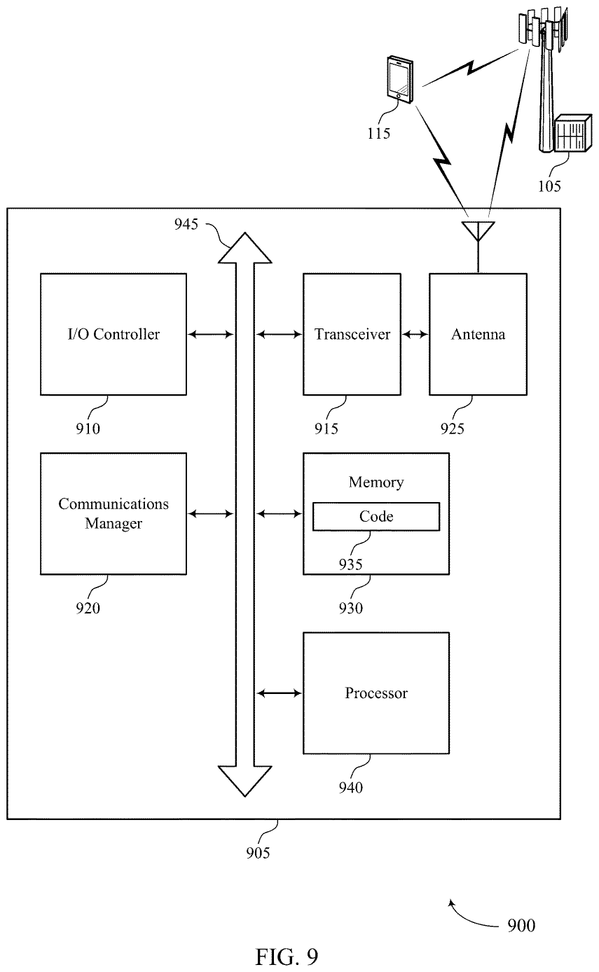

FIG. 9 shows a diagram of a system 900 including a device 905 that supports failure detection for communication power state switching in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting failure detection for communication power state switching). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communication by a UE in accordance with examples as disclosed herein. For example, the communications manager 920 is capable of, configured to, or operable to support a means for receiving control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The communications manager 920 is capable of, configured to, or operable to support a means for determining that the UE is to perform an RLF or BF detection operation. The communications manager 920 is capable of, configured to, or operable to support a means for applying a second schedule for the UE to transition between the set of multiple power states based on the determination that the UE is to perform the RLF or BF detection operation.

Additionally, or alternatively, the communications manager 920 may support wireless communication by a UE in accordance with examples as disclosed herein. For example, the communications manager 920 is capable of, configured to, or operable to support a means for receiving control information that indicates a schedule for the UE to transition between a set of multiple power states, where the set of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions. The communications manager 920 is capable of, configured to, or operable to support a means for transmitting an uplink message. The communications manager 920 is capable of, configured to, or operable to support a means for modifying operation of a HARQ RTT timer based on a first state of the set of multiple power states that the UE is in, where the HARQ RTT timer defines a minimum duration of time between transmission of the uplink message and receipt of a retransmission grant that pertains to retransmission by the UE of the uplink message.

By including or configuring the communications manager 920 in accordance with examples as described herein, the device 905 may support techniques for reduced latency, reduced power consumption, improved utilization of processing capabilities, and longer battery life. For example, the device 905 may reduce power consumption and improve battery life by transitioning between power states according to a schedule as described herein. Moreover, by configuring the device 905 with multiple schedules, the device 905 may adaptively postpone a transition to a power state in order to perform an RLF or BF detection operation, which may improve performance and reliability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of failure detection for communication power state switching as described herein, or the at least one processor 940 and the at least one memory 930 may be otherwise configured to, individually or collectively, perform or support such operations.

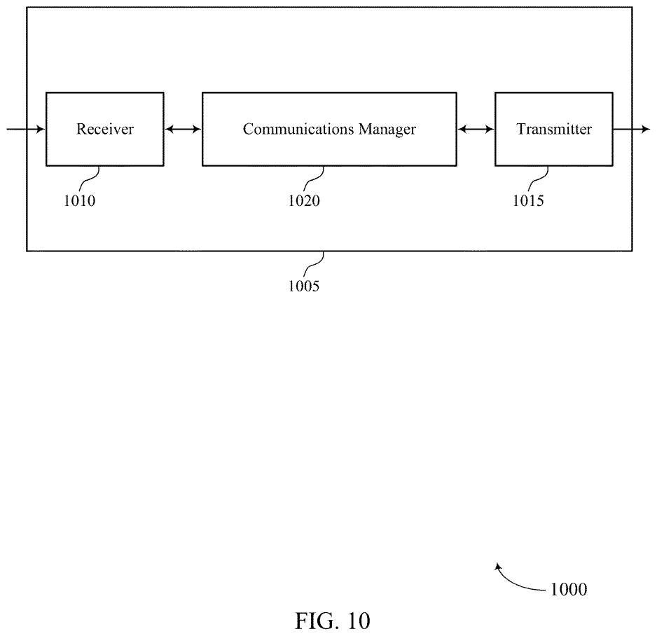

FIG. 10 shows a block diagram 1000 of a device 1005 that supports failure detection for communication power state switching in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of failure detection for communication power state switching as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication by a network entity in accordance with examples as disclosed herein. For example, the communications manager 1020 is capable of, configured to, or operable to support a means for transmitting, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The communications manager 1020 is capable of, configured to, or operable to support a means for determining that the UE is to perform an RLF or BF detection operation. The communications manager 1020 is capable of, configured to, or operable to support a means for transmitting, to the UE, a message that triggers the UE to transition from the first schedule to a second schedule for the UE to transition between the set of multiple power states based on the determination that the UE is to perform the RLF or BF detection operation.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing and more efficient utilization of communication resources. For example, by utilizing one or more schedules as described herein, the device 1005 may enable a UE in communication with the device 1005 to perform an RLF or BF detection operation prior to transitioning to an uplink-only power state. By performing the RLF or BF detection operation, the UE and the device 1005 may avoid RLF or BF, thereby reducing processing and preventing additional resource utilization associated with connection re-establishment procedures.

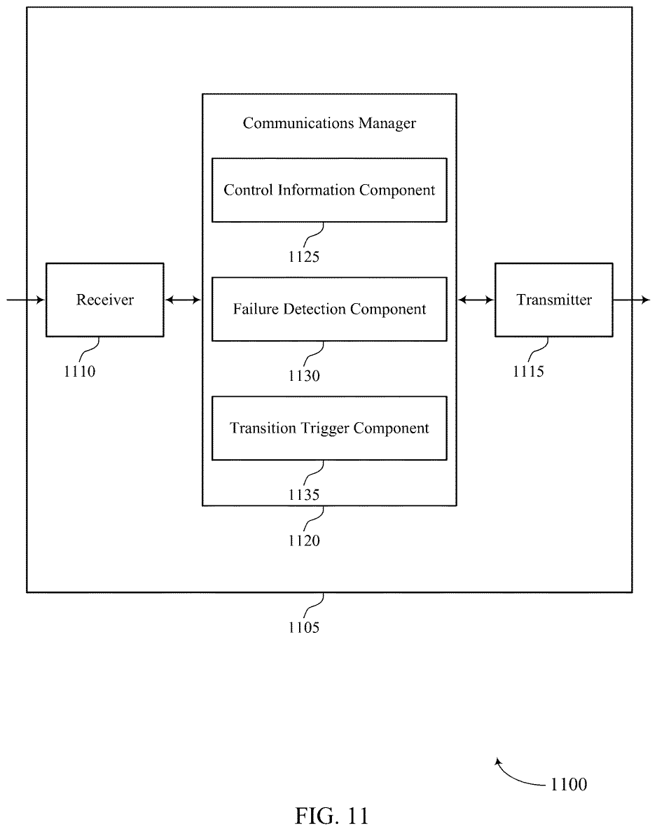

FIG. 11 shows a block diagram 1100 of a device 1105 that supports failure detection for communication power state switching in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of failure detection for communication power state switching as described herein. For example, the communications manager 1120 may include a control information component 1125, a failure detection component 1130, a transition trigger component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication by a network entity in accordance with examples as disclosed herein. The control information component 1125 is capable of, configured to, or operable to support a means for transmitting, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The failure detection component 1130 is capable of, configured to, or operable to support a means for determining that the UE is to perform an RLF or BF detection operation. The transition trigger component 1135 is capable of, configured to, or operable to support a means for transmitting, to the UE, a message that triggers the UE to transition from the first schedule to a second schedule for the UE to transition between the set of multiple power states based on the determination that the UE is to perform the RLF or BF detection operation.

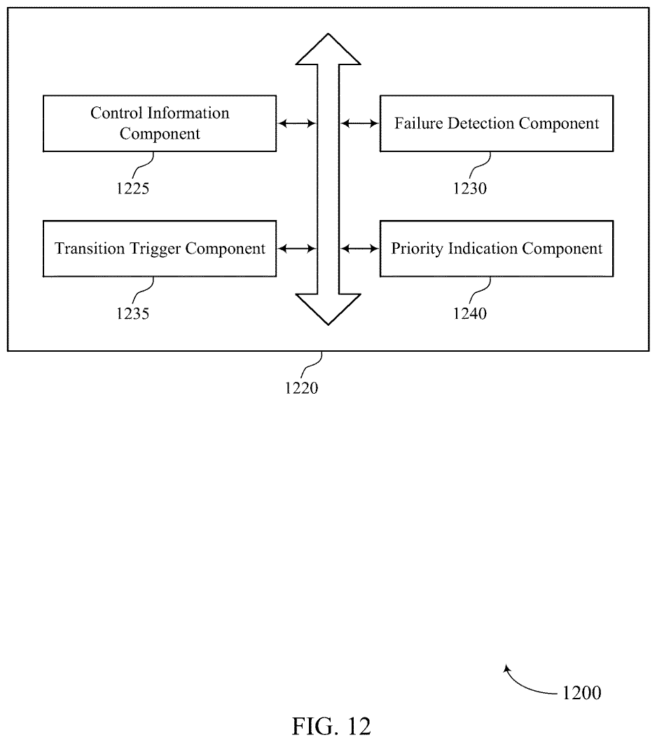

FIG. 12 shows a block diagram 1200 of a communications manager 1220 that supports failure detection for communication power state switching in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of failure detection for communication power state switching as described herein. For example, the communications manager 1220 may include a control information component 1225, a failure detection component 1230, a transition trigger component 1235, a priority indication component 1240, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication by a network entity in accordance with examples as disclosed herein. The control information component 1225 is capable of, configured to, or operable to support a means for transmitting, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The failure detection component 1230 is capable of, configured to, or operable to support a means for determining that the UE is to perform an RLF or BF detection operation. The transition trigger component 1235 is capable of, configured to, or operable to support a means for transmitting, to the UE, a message that triggers the UE to transition from the first schedule to a second schedule for the UE to transition between the set of multiple power states based on the determination that the UE is to perform the RLF or BF detection operation.

In some examples, to support transmitting the message that triggers the UE to transition from the first schedule to the second schedule, the control information component 1225 is capable of, configured to, or operable to support a means for transmitting a DCI message that activates the RLF or BF detection operation.

In some examples, the second schedule includes a postponement of a transition from the second state to the uplink-only state until after an expiration of a failure detection timer associated with the RLF or BF detection operation.

In some examples, the DCI message includes an indication that the UE is to apply the second schedule.

In some examples, to support transmitting the message that triggers the UE to transition from the first schedule to the second schedule, the transition trigger component 1235 is capable of, configured to, or operable to support a means for transmitting a WUS associated with an indication that the UE is to perform the RLF or BF detection operation, where the second schedule includes a postponement of a transition from the second state to the uplink-only state.

In some examples, the WUS includes an indication of the second schedule. In some examples, the second schedule includes a transition to the uplink-only state after completion of the RLF or BF detection operation.

In some examples, the message that triggers the UE to transition from the first schedule to the second schedule further indicates a set of multiple schedules for the UE to transition between the set of multiple power states, and the priority indication component 1240 is capable of, configured to, or operable to support a means for transmitting a priority indication associated with the RLF or BF detection operation.

In some examples, each of the set of multiple schedules includes a respective timer duration for postponement of a transition from the second state to the uplink-only state.

In some examples, to support transmitting the message that triggers the UE to transition from the first schedule to the second schedule, the transition trigger component 1235 is capable of, configured to, or operable to support a means for transmitting a WUS associated with an indication that the UE is to perform the RLF or BF detection operation, where the second schedule includes a transition from the uplink-only state to the second state.

In some examples, the transition trigger component 1235 is capable of, configured to, or operable to support a means for transmitting an indication of a duration of time from receipt of the WUS and the transition from the uplink-only state to the second state.

In some examples, the transition trigger component 1235 is capable of, configured to, or operable to support a means for receiving an uplink message including an indication that the second schedule is applied at the UE. In some examples, the failure detection component 1230 is capable of, configured to, or operable to support a means for transmitting, based on receiving the uplink message, one or more downlink signals for the RLF or BF detection operation at the UE, where the uplink message is one of an uplink control information message, a medium access control (MAC) control element (CE), or a PUSCH message to which the indication is piggybacked.

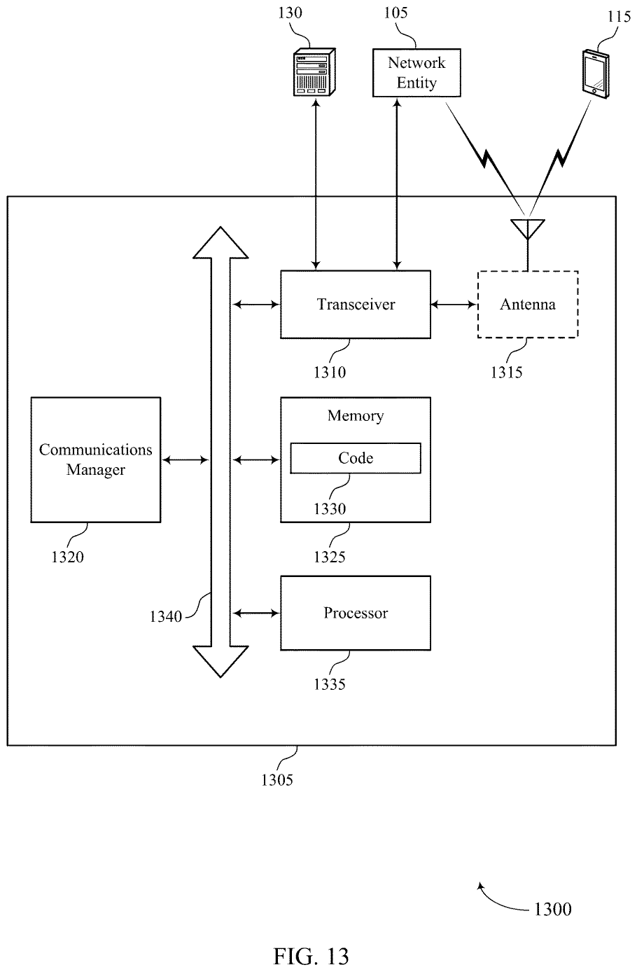

FIG. 13 shows a diagram of a system 1300 including a device 1305 that supports failure detection for communication power state switching in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting failure detection for communication power state switching). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some implementations, the at least one processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the at least one processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication by a network entity in accordance with examples as disclosed herein. For example, the communications manager 1320 is capable of, configured to, or operable to support a means for transmitting, to a UE, control information that indicates a first schedule for the UE to transition between a set of multiple power states, where the set of multiple power states includes an uplink-only state during which a primary radio of the UE is used for uplink transmissions, and a second state during which the primary radio of the UE is used at least for downlink transmissions. The communications manager 1320 is capable of, configured to, or operable to support a means for determining that the UE is to perform an RLF or BF detection operation. The communications manager 1320 is capable of, configured to, or operable to support a means for transmitting, to the UE, a message that triggers the UE to transition from the first schedule to a second schedule for the UE to transition between the set of multiple power states based on the determination that the UE is to perform the RLF or BF detection operation.

By including or configuring the communications manager 1320 in accordance with examples as described herein, the device 1305 may support techniques for reduced processing and more efficient utilization of communication resources. For example, by utilizing one or more schedules for transitioning between power states, the device 1305 may improve coordination between devices and reduce latency. By enabling a UE in communication with the device 1305 to perform an RLF or BF detection operation procedure before transitioning to an uplink-only power state, the device 1305 may improve communication reliability. Further, the device 1305 may prevent RLF or BF with the UE, thereby reducing latency.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of failure detection for communication power state switching as described herein, or the at least one processor 1335 and the at least one memory 1325 may be otherwise configured to, individually or collectively, perform or support such operations.

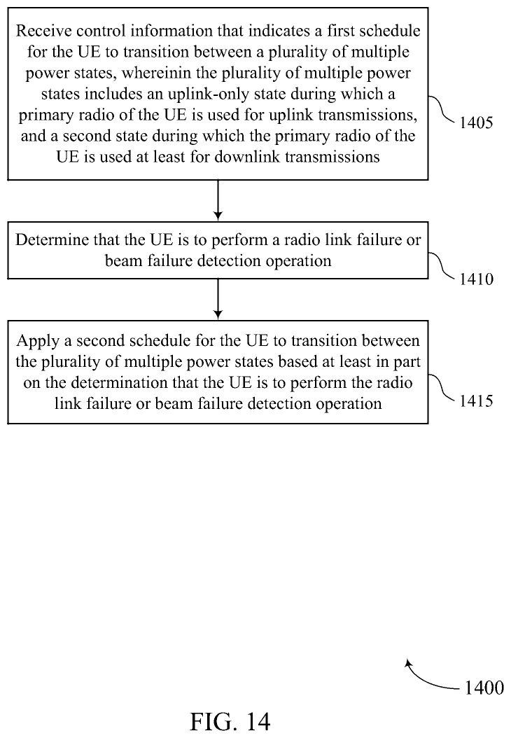

FIG. 14 shows a flowchart illustrating a method 1400 that supports failure detection for communication power state switching in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a plurality of instructions to control the functional elements of the UE to perform the described functions. Additionally, or alternatively, the UE may perform aspects of the described functions using special-purpose hardware.

At 1405, the method may include receiving control information that indicates a first schedule for the UE to transition between a plurality of multiple power states, wherein the plurality of multiple power states includes an uplink-only state during which a primary radio of the UE is used for uplink transmissions, and a second state during which the primary radio of the UE is used at least for downlink transmissions. The operations of block 1405 may be performed in accordance with examples as disclosed herein. In some examples, aspects of the operations of 1405 may be performed by a control information component 825 as described with reference to FIG. 8.

At 1410, the method may include determining that the UE is to perform an RLF or BF detection operation. The operations of block 1410 may be performed in accordance with examples as disclosed herein. In some examples, aspects of the operations of 1410 may be performed by a failure detection component 830 as described with reference to FIG. 8.

At 1415, the method may include applying a second schedule for the UE to transition between the plurality of multiple power states based at least in part on the determination that the UE is to perform the RLF or BF detection operation. The operations of block 1415 may be performed in accordance with examples as disclosed herein. In some examples, aspects of the operations of 1415 may be performed by a schedule component 835 as described with reference to FIG. 8.

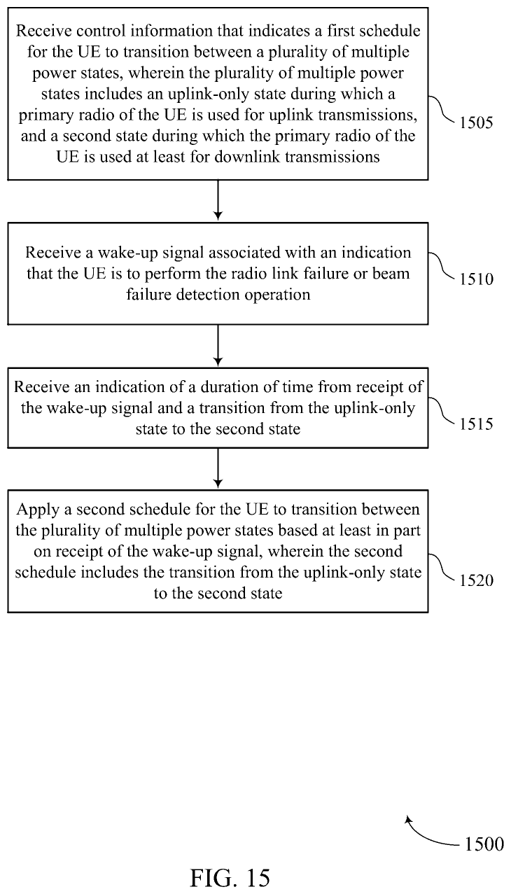

FIG. 15 shows a flowchart illustrating a method 1500 that supports failure detection for communication power state switching in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a plurality of instructions to control the functional elements of the UE to perform the described functions. Additionally, or alternatively, the UE may perform aspects of the described functions using special-purpose hardware.

At 1505, the method may include receiving control information that indicates a first schedule for the UE to transition between a plurality of multiple power states, wherein the plurality of multiple power states includes an uplink-only state during which a primary radio of the UE is used for uplink transmissions, and a second state during which the primary radio of the UE is used at least for downlink transmissions. The operations of block 1505 may be performed in accordance with examples as disclosed herein. In some examples, aspects of the operations of 1505 may be performed by a control information component 825 as described with reference to FIG. 8.

At 1510, the method may include receiving a WUS associated with an indication that the UE is to perform the RLF or BF detection operation. The operations of block 1510 may be performed in accordance with examples as disclosed herein. In some examples, aspects of the operations of 1510 may be performed by a WUS component 850 as described with reference to FIG. 8.

At 1520, the method may include receiving an indication of a duration of time from receipt of the WUS and a transition from the uplink-only state to the second state. The operations of block 1520 may be performed in accordance with examples as disclosed herein. In some examples, aspects of the operations of 1520 may be performed by a schedule component 835 as described with reference to FIG. 8.

At 1525, the method may include applying a second schedule for the UE to transition between the plurality of multiple power states based at least in part on the WUS, wherein the second schedule includes the transition from the uplink-only state to the second state. The operations of block 1525 may be performed in accordance with examples as disclosed herein. In some examples, aspects of the operations of 1525 may be performed by a schedule component 835 as described with reference to FIG. 8.

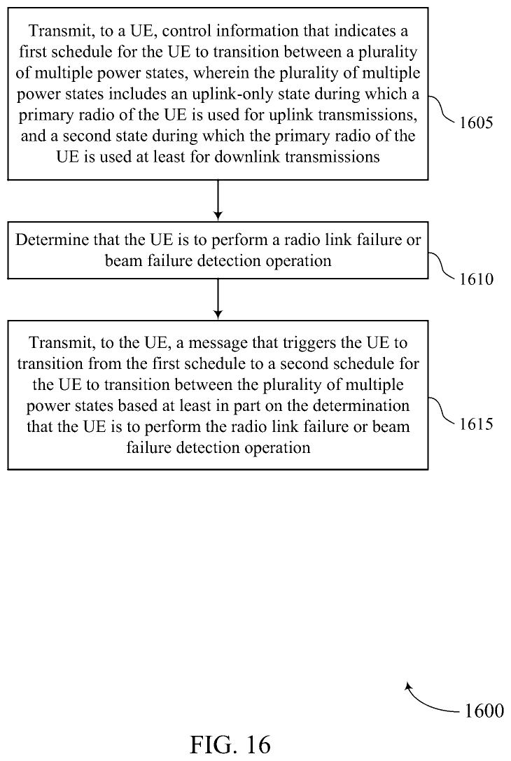

FIG. 16 shows a flowchart illustrating a method 1600 that supports failure detection for communication power state switching in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a plurality of instructions to control the functional elements of the network entity to perform the described functions. Additionally, or alternatively, the network entity may perform aspects of the described functions using special-purpose hardware.

At 1605, the method may include transmitting, to a UE, control information that indicates a first schedule for the UE to transition between a plurality of multiple power states, wherein the plurality of multiple power states includes an uplink-only state during which a primary radio of the UE is used for uplink transmissions, and a second state during which the primary radio of the UE is used at least for downlink transmissions. The operations of block 1605 may be performed in accordance with examples as disclosed herein. In some examples, aspects of the operations of 1605 may be performed by a control information component 1225 as described with reference to FIG. 12.

At 1610, the method may include determining that the UE is to perform an RLF or BF detection operation. The operations of block 1610 may be performed in accordance with examples as disclosed herein. In some examples, aspects of the operations of 1610 may be performed by a failure detection component 1230 as described with reference to FIG. 12.

At 1615, the method may include transmitting, to the UE, a message that triggers the UE to transition from the first schedule to a second schedule for the UE to transition between the plurality of multiple power states based at least in part on the determination that the UE is to perform the RLF or BF detection operation. The operations of block 1615 may be performed in accordance with examples as disclosed herein. In some examples, aspects of the operations of 1615 may be performed by a transition trigger component 1235 as described with reference to FIG. 12.

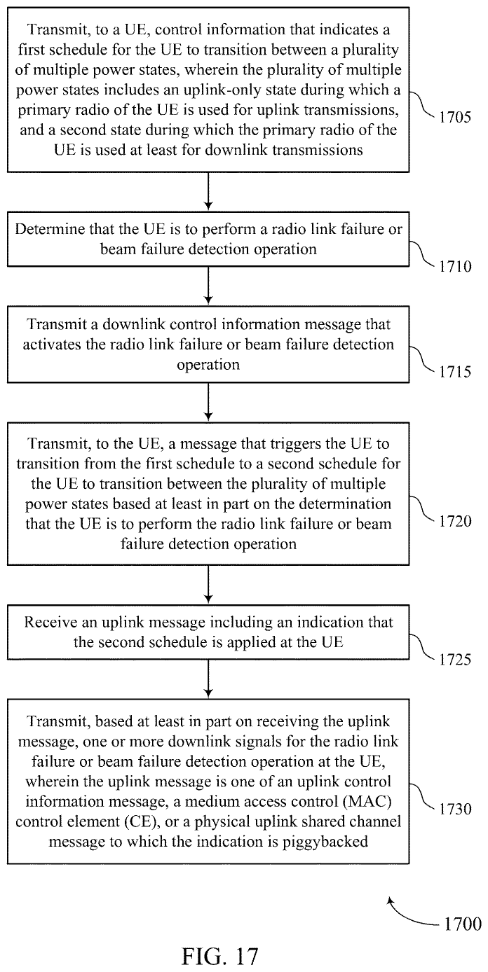

FIG. 17 shows a flowchart illustrating a method 1700 that supports failure detection for communication power state switching in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a plurality of instructions to control the functional elements of the network entity to perform the described functions. Additionally, or alternatively, the network entity may perform aspects of the described functions using special-purpose hardware.

At 1705, the method may include transmitting, to a UE, control information that indicates a first schedule for the UE to transition between a plurality of multiple power states, wherein the plurality of multiple power states includes an uplink-only state during which a primary radio of the UE is used for uplink transmissions, and a second state during which the primary radio of the UE is used at least for downlink transmissions. The operations of block 1705 may be performed in accordance with examples as disclosed herein. In some examples, aspects of the operations of 1705 may be performed by a control information component 1225 as described with reference to FIG. 12.

At 1710, the method may include determining that the UE is to perform an RLF or BF detection operation. The operations of block 1710 may be performed in accordance with examples as disclosed herein. In some examples, aspects of the operations of 1710 may be performed by a failure detection component 1230 as described with reference to FIG. 12.

At 1715, the method may include transmitting a DCI message that activates the RLF or BF detection operation. The operations of block 1715 may be performed in accordance with examples as disclosed herein. In some examples, aspects of the operations of 1715 may be performed by a control information component 1225 as described with reference to FIG. 12.

At 1720, the method may include transmitting, to the UE, a message that triggers the UE to transition from the first schedule to a second schedule for the UE to transition between the plurality of multiple power states based at least in part on the determination that the UE is to perform the RLF or BF detection operation. The operations of block 1720 may be performed in accordance with examples as disclosed herein. In some examples, aspects of the operations of 1720 may be performed by a transition trigger component 1235 as described with reference to FIG. 12.

At 1725, the method may include receiving an uplink message including an indication that the second schedule is applied at the UE. The operations of block 1725 may be performed in accordance with examples as disclosed herein. In some examples, aspects of the operations of 1725 may be performed by a transition trigger component 1235 as described with reference to FIG. 12.

At 1730, the method may include transmitting, based at least in part on receiving the uplink message, one or more downlink signals for the RLF or BF detection operation at the UE, wherein the uplink message is one of an uplink control information message, a MAC-CE, or a PUSCH message to which the indication is piggy backed. The operations of block 1730 may be performed in accordance with examples as disclosed herein. In some examples, aspects of the operations of 1730 may be performed by a failure detection component 1230 as described with reference to FIG. 12.

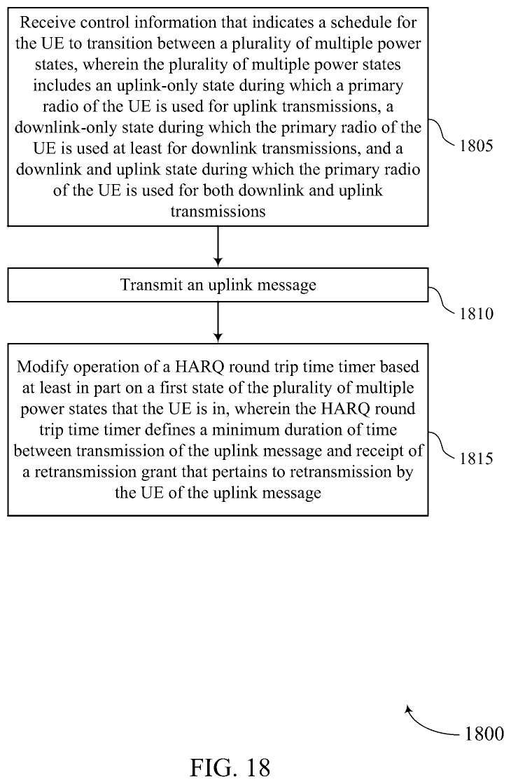

FIG. 18 shows a flowchart illustrating a method 1800 that supports failure detection for communication power state switching in accordance with aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a plurality of instructions to control the functional elements of the UE to perform the described functions. Additionally, or alternatively, the UE may perform aspects of the described functions using special-purpose hardware.

At 1805, the method may include receiving control information that indicates a schedule for the UE to transition between a plurality of multiple power states, wherein the plurality of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions. The operations of block 1805 may be performed in accordance with examples as disclosed herein. In some examples, aspects of the operations of 1805 may be performed by a control information component 825 as described with reference to FIG. 8.

At 1810, the method may include transmitting an uplink message. The operations of block 1810 may be performed in accordance with examples as disclosed herein. In some examples, aspects of the operations of 1810 may be performed by an uplink message component 840 as described with reference to FIG. 8.

At 1815, the method may include modifying operation of a HARQ RTT timer based at least in part on a first state of the plurality of multiple power states that the UE is in, wherein the HARQ RTT timer defines a minimum duration of time between transmission of the uplink message and receipt of a retransmission grant that pertains to retransmission by the UE of the uplink message. The operations of block 1815 may be performed in accordance with examples as disclosed herein. In some examples, aspects of the operations of 1815 may be performed by a HARQ RTT timer component 845 as described with reference to FIG. 8.

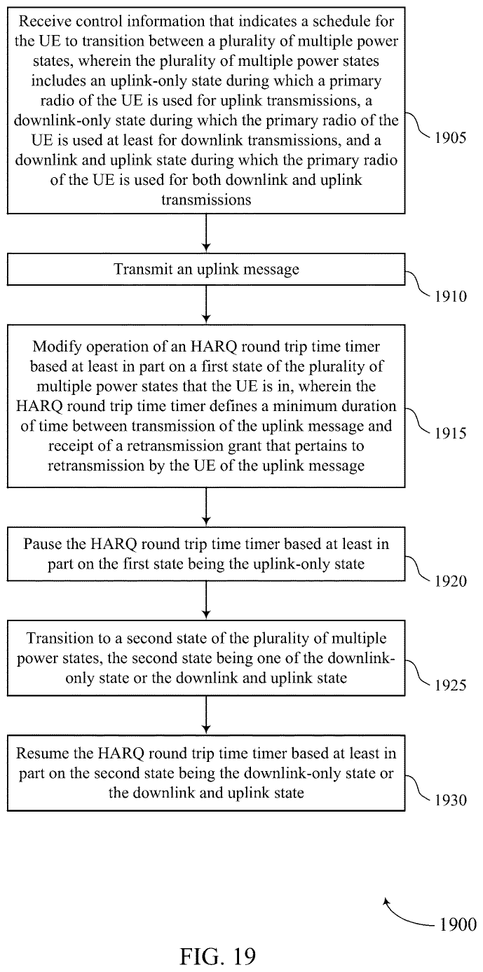

FIG. 19 shows a flowchart illustrating a method 1900 that supports failure detection for communication power state switching in accordance with aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a plurality of instructions to control the functional elements of the UE to perform the described functions. Additionally, or alternatively, the UE may perform aspects of the described functions using special-purpose hardware.

At 1905, the method may include receiving control information that indicates a schedule for the UE to transition between a plurality of multiple power states, wherein the plurality of multiple power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions. The operations of block 1905 may be performed in accordance with examples as disclosed herein. In some examples, aspects of the operations of 1905 may be performed by a control information component 825 as described with reference to FIG. 8.

At 1910, the method may include transmitting an uplink message. The operations of block 1910 may be performed in accordance with examples as disclosed herein. In some examples, aspects of the operations of 1910 may be performed by an uplink message component 840 as described with reference to FIG. 8.

At 1915, the method may include modifying operation of a HARQ RTT timer based at least in part on a first state of the plurality of multiple power states that the UE is in, wherein the HARQ RTT timer defines a minimum duration of time between transmission of the uplink message and receipt of a retransmission grant that pertains to retransmission by the UE of the uplink message. The operations of block 1915 may be performed in accordance with examples as disclosed herein. In some examples, aspects of the operations of 1915 may be performed by a HARQ RTT timer component 845 as described with reference to FIG. 8.

At 1920, the method may include pausing the HARQ RTT timer based at least in part on the first state being the uplink-only state. The operations of block 1920 may be performed in accordance with examples as disclosed herein. In some examples, aspects of the operations of 1920 may be performed by a HARQ RTT timer component 845 as described with reference to FIG. 8.

At 1925, the method may include transitioning to a second state of the plurality of multiple power states, the second state being one of the downlink-only state or the downlink and uplink state. The operations of block 1925 may be performed in accordance with examples as disclosed herein. In some examples, aspects of the operations of 1925 may be performed by a power state transition component 860 as described with reference to FIG. 8.

At 1930, the method may include resuming the HARQ RTT timer based at least in part on the second state being the downlink-only state or the downlink and uplink state. The operations of block 1930 may be performed in accordance with examples as disclosed herein. In some examples, aspects of the operations of 1930 may be performed by a HARQ RTT timer component 845 as described with reference to FIG. 8. The following provides an overview of aspects of the present disclosure:

Aspect 1: A method for wireless communication by a UE, comprising: receiving control information that indicates a first schedule for the UE to transition between a plurality of power states, wherein the plurality of power states includes an uplink-only state during which a primary radio of the UE is used for uplink transmissions, and a second state during which the primary radio of the UE is used at least for downlink transmissions; determining that the UE is to perform a RLF/BF detection operation; and applying a second schedule for the UE to transition between the plurality of power states based at least in part on the determination that the UE is to perform the RLF/BF detection operation.

Aspect 2: The method of aspect 1, wherein determining that the UE is to perform the RLF/BF detection operation comprises: receiving a DCI message that activates the RLF/BF detection operation, wherein applying the second schedule is based at least in part on receipt of the DCI message.

Aspect 3: The method of aspect 2, wherein the second schedule includes a postponement of a transition from the second state to the uplink-only state until after an expiration of a failure detection timer associated with the RLF/BF detection operation.

Aspect 4: The method of any of aspects 2 through 3, wherein receiving the DCI message comprises: receiving an indication that the UE is to apply the second schedule.

Aspect 5: The method of aspect 1, wherein determining that the UE is to perform the RLF/BF detection operation comprises: receiving a WUS associated with an indication that the UE is to perform the RLF/BF detection operation, wherein applying the second schedule is based at least in part on receipt of the WUS, and wherein the second schedule includes a postponement of a transition from the second state to the uplink-only state; and performing the RLF/BF detection operation after applying the second schedule.

Aspect 6: The method of aspect 5, wherein the WUS includes an indication of the second schedule, and the second schedule includes a transition to the uplink-only state after completion of the RLF/BF detection operation.

Aspect 7: The method of any of aspects 1 through 6, wherein the control information further indicates a plurality of schedules for the UE to transition between the plurality of power states, wherein the plurality of schedules includes at least the first schedule and the second schedule, the method further comprising: receiving a priority indication associated with the RLF/BF detection operation; and selecting the second schedule from the plurality of schedules based at least in part on the priority indication of the RLF/BF detection operation.

Aspect 8: The method of aspect 7, wherein each of the plurality of schedules includes a respective timer duration for postponement of a transition from the second state to the uplink-only state, wherein selecting the second schedule from the plurality of schedules comprises: selecting the second schedule based at least in part on an association between the respective timer duration of the second schedule and the priority indication.

Aspect 9: The method of aspect 8, wherein the association includes that a higher priority is associated with a longer timer duration prior to a transition from the second state to the uplink-only state and a lower priority is associated with a shorter timer duration prior to the transition from the second state to the uplink-only state.

Aspect 10: The method of aspect 1, wherein determining that the UE is to perform the RLF/BF detection operation comprises: receiving a WUS associated with an indication that the UE is to perform the RLF/BF detection operation, wherein applying the second schedule is based at least in part on receipt of the WUS, and wherein the second schedule includes a transition from the uplink-only state to the second state.

Aspect 11: The method of aspect 10, further comprising: receiving an indication of a duration of time from receipt of the WUS and the transition from the uplink-only state to the second state.

Aspect 12: The method of any of aspects 1 through 11, further comprising: performing the RLF/BF detection operation; and detecting at least one failure instance during the RLF/BF detection operation, wherein applying the second schedule is based at least in part on detecting the at least one failure instance, and wherein the second schedule comprises a postponement of a transition from the second state to the uplink-only state.

Aspect 13: The method of aspect 12, wherein the postponement of the transition from the second state to the uplink-only state is until after an expiration of a failure detection timer associated with the RLF/BF detection operation.

Aspect 14: The method of any of aspects 12 through 13, wherein the control information further indicates a plurality of schedules for the UE to transition between the plurality of power states, the plurality of schedules including at least the first schedule and the second schedule, the method further comprising: selecting the second schedule from the plurality of schedules based at least in part on detecting the at least one failure instance.

Aspect 15: The method of any of aspects 12 through 14, further comprising: transmitting an uplink message including an indication that the second schedule is applied; and receiving, based at least in part on transmitting the uplink message, one or more downlink signals for performing the RLF/BF detection operation, wherein the uplink message is one of an uplink control information message, a MAC-CE, or a PUSCH message to which the indication is piggybacked.

Aspect 16: A method for wireless communication by a network entity, comprising: transmitting, to a UE, control information that indicates a first schedule for the UE to transition between a plurality of power states, wherein the plurality of power states includes an uplink-only state during which a primary radio of the UE is used for uplink transmissions, and a second state during which the primary radio of the UE is used at least for downlink transmissions; determining that the UE is to perform a RLF/BF detection operation; and transmitting, to the UE, a message that triggers the UE to transition from the first schedule to a second schedule for the UE to transition between the plurality of power states based at least in part on the determination that the UE is to perform the RLF/BF detection operation.

Aspect 17: The method of aspect 16, wherein transmitting the message that triggers the UE to transition from the first schedule to the second schedule comprises: transmitting a DCI message that activates the RLF/BF detection operation.

Aspect 18: The method of aspect 17, wherein the second schedule includes a postponement of a transition from the second state to the uplink-only state until after an expiration of a failure detection timer associated with the RLF/BF detection operation.

Aspect 19: The method of any of aspects 17 through 18, wherein the DCI message includes an indication that the UE is to apply the second schedule.

Aspect 20: The method of aspect 16, wherein transmitting the message that triggers the UE to transition from the first schedule to the second schedule comprises: transmitting a WUS associated with an indication that the UE is to perform the RLF/BF detection operation, wherein the second schedule includes a postponement of a transition from the second state to the uplink-only state.

Aspect 21: The method of aspect 20, wherein the WUS includes an indication of the second schedule, and the second schedule includes a transition to the uplink-only state after completion of the RLF/BF detection operation.

Aspect 22: The method of any of aspects 16 through 21, wherein the message that triggers the UE to transition from the first schedule to the second schedule further indicates a plurality of schedules for the UE to transition between the plurality of power states, and wherein the plurality of schedules includes at least the first schedule and the second schedule, the method further comprising: transmitting a priority indication associated with the RLF/BF detection operation.

Aspect 23: The method of aspect 22, wherein each of the plurality of schedules includes a respective timer duration for postponement of a transition from the second state to the uplink-only state.

Aspect 24: The method of aspect 16, wherein transmitting the message that triggers the UE to transition from the first schedule to the second schedule comprises: transmitting a WUS associated with an indication that the UE is to perform the RLF/BF detection operation, wherein the second schedule includes a transition from the uplink-only state to the second state.

Aspect 25: The method of aspect 24, further comprising: transmitting an indication of a duration of time from receipt of the WUS and the transition from the uplink-only state to the second state.

Aspect 26: The method of any of aspects 16 through 25, further comprising: receiving an uplink message including an indication that the second schedule is applied at the UE; and transmitting, based at least in part on receiving the uplink message, one or more downlink signals for the RLF/BF detection operation at the UE, wherein the uplink message is one of an uplink control information message, a MAC-CE, or a PUSCH message to which the indication is piggybacked.

Aspect 27: A method for wireless communication by a UE, comprising: receiving control information that indicates a schedule for the UE to transition between a plurality of power states, wherein the plurality of power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions; transmitting an uplink message; and modifying operation of an HARQ RTT timer based at least in part on a first state of the plurality of power states that the UE is in, wherein the HARQ RTT timer defines a minimum duration of time between transmission of the uplink message and receipt of a retransmission grant that pertains to retransmission by the UE of the uplink message.

Aspect 28: The method of aspect 27, wherein modifying operation of the HARQ RTT timer comprises: pausing the HARQ RTT timer based at least in part on the first state being the downlink-only state.

Aspect 29: The method of any of aspect 27, wherein modifying operation of the HARQ RTT timer comprises: refraining from initiating the HARQ RTT timer based at least in part on the first state being the uplink-only state.

Aspect 30: The method of aspect 27, wherein modifying operation of the HARQ RTT timer comprises: initiating the HARQ RTT timer based at least in part on the first state being the downlink-only state or the downlink and uplink state.

Aspect 31: The method of aspect 27, wherein modifying operation of the HARQ RTT timer comprises: pausing the HARQ RTT timer based at least in part on the first state being the uplink-only state.

Aspect 32: The method of aspect 31, further comprising: transitioning to a second state of the plurality of power states, the second state being one of the downlink-only state or the downlink and uplink state; and resuming the HARQ RTT timer based at least in part on the second state being the downlink-only state or the downlink and uplink state.

Aspect 33: A UE for wireless communication, comprising one or more memories storing processor-executable code; and one or more processors coupled with the one or more memories and individually or collectively operable to execute the code to cause the UE to perform a method of any of aspects 1 through 15.

Aspect 34: A UE for wireless communication, comprising at least one means for performing a method of any of aspects 1 through 15.

Aspect 35: A non-transitory computer-readable medium storing code for wireless communication by a UE, the code comprising instructions executable by one or more processors to perform a method of any of aspects 1 through 15.

Aspect 36: A network entity for wireless communication, comprising one or more memories storing processor-executable code; and one or more processors coupled with the one or more memories and individually or collectively operable to execute the code to cause the network entity to perform a method of any of aspects 16 through 26.

Aspect 37: A network entity for wireless communication, comprising at least one means for performing a method of any of aspects 16 through 26.

Aspect 38: A non-transitory computer-readable medium storing code for wireless communication by a network entity, the code comprising instructions executable by one or more processors to perform a method of any of aspects 16 through 26.

Aspect 39: A UE for wireless communication, comprising one or more memories storing processor-executable code; and one or more processors coupled with the one or more memories and individually or collectively operable to execute the code to cause the UE to perform a method of any of aspects 27 through 32.

Aspect 40: A UE for wireless communication, comprising at least one means for performing a method of any of aspects 27 through 32.

Aspect 41: A non-transitory computer-readable medium storing code for wireless communication by a UE, the code comprising instructions executable by one or more processors to perform a method of any of aspects 27 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
one or more memories storing processor-executable code; and
one or more processors coupled with the one or more memories and individually or collectively operable to execute the code to cause the UE to:
receive control information that indicates a first schedule for the UE to transition between a plurality of power states, wherein the plurality of power states includes an uplink-only state during which a primary radio of the UE is used for uplink transmissions, and a second state during which the primary radio of the UE is used at least for downlink transmissions;
determine that the UE is to perform a radio link failure or beam failure detection operation; and
apply a second schedule for the UE to transition between the plurality of power states based at least in part on the determination that the UE is to perform the radio link failure or beam failure detection operation.

2. The UE of claim 1, wherein, to determine that the UE is to perform the radio link failure or beam failure detection operation, the one or more processors are individually or collectively operable to execute the code to cause the UE to:
receive a downlink control information message that activates the radio link failure or beam failure detection operation, wherein applying the second schedule is based at least in part on receipt of the downlink control information message.

3. The UE of claim 2, wherein the second schedule includes a postponement of a transition from the second state to the uplink-only state until after an expiration of a failure detection timer associated with the radio link failure or beam failure detection operation.

4. The UE of claim 2, wherein, to receive the downlink control information message, the one or more processors are individually or collectively operable to execute the code to cause the UE to:
receive an indication that the UE is to apply the second schedule.

5. The UE of claim 1, wherein, to determine that the UE is to perform the radio link failure or beam failure detection operation, the one or more processors are individually or collectively operable to execute the code to cause the UE to:
receive a wake-up signal associated with an indication that the UE is to perform the radio link failure or beam failure detection operation, wherein applying the second schedule is based at least in part on receipt of the wake-up signal, and wherein the second schedule includes a postponement of a transition from the second state to the uplink-only state; and
perform the radio link failure or beam failure detection operation after applying the second schedule.

6. The UE of claim 5, wherein:
the wake-up signal includes an indication of the second schedule, and
the second schedule includes a transition to the uplink-only state after completion of the radio link failure or beam failure detection operation.

7. The UE of claim 1, wherein the control information further indicates a plurality of schedules for the UE to transition between the plurality of power states, and the one or more processors are individually or collectively further operable to execute the code to cause the UE to:
receive a priority indication associated with the radio link failure or beam failure detection operation; and
select the second schedule from the plurality of schedules based at least in part on the priority indication of the radio link failure or beam failure detection operation.

8. The UE of claim 7, wherein each of the plurality of schedules includes a respective timer duration for postponement of a transition from the second state to the uplink-only state, and wherein, to select the second schedule from the plurality of schedules, the one or more processors are individually or collectively operable to execute the code to cause the UE to:
select the second schedule based at least in part on an association between the respective timer duration of the second schedule and the priority indication.

9. The UE of claim 8, wherein the association includes that a higher priority is associated with a longer timer duration prior to a transition from the second state to the uplink-only state and a lower priority is associated with a shorter timer duration prior to the transition from the second state to the uplink-only state.

10. The UE of claim 1, wherein, to determine that the UE is to perform the radio link failure or beam failure detection operation, the one or more processors are individually or collectively operable to execute the code to cause the UE to:
receive a wake-up signal associated with an indication that the UE is to perform the radio link failure or beam failure detection operation, wherein applying the second schedule is based at least in part on receipt of the wake-up signal, and wherein the second schedule includes a transition from the uplink-only state to the second state.

11. The UE of claim 10, wherein the one or more processors are individually or collectively further operable to execute the code to cause the UE to:
receive an indication of a duration of time from receipt of the wake-up signal and the transition from the uplink-only state to the second state.

12. The UE of claim 1, wherein the one or more processors are individually or collectively further operable to execute the code to cause the UE to:
perform the radio link failure or beam failure detection operation; and
detect at least one failure instance during the radio link failure or beam failure detection operation, wherein applying the second schedule is based at least in part on detecting the at least one failure instance, and wherein the second schedule comprises a postponement of a transition from the second state to the uplink-only state.

13. The UE of claim 12, wherein the postponement of the transition from the second state to the uplink-only state is until after an expiration of a failure detection timer associated with the radio link failure or beam failure detection operation.

14. The UE of claim 12, wherein the control information further indicates a plurality of schedules for the UE to transition between the plurality of power states, and the one or more processors are individually or collectively further operable to execute the code to cause the UE to:
select the second schedule from the plurality of schedules based at least in part on detecting the at least one failure instance.

15. The UE of claim 12, wherein the one or more processors are individually or collectively further operable to execute the code to cause the UE to:
transmit an uplink message including an indication that the second schedule is applied; and
receive, based at least in part on transmitting the uplink message, one or more downlink signals for performing the radio link failure or beam failure detection operation, wherein the uplink message is one of an uplink control information message, a medium access control (MAC) control element (CE), or a physical uplink shared channel message to which the indication is piggybacked.

16-23. (canceled)

24. A user equipment (UE) for wireless communication, comprising:
one or more memories storing processor-executable code; and
one or more processors coupled with the one or more memories and individually or collectively operable to execute the code to cause the UE to:
receive control information that indicates a schedule for the UE to transition between a plurality of power states, wherein the plurality of power states includes an uplink-only state during which a primary radio of the UE is used for uplink transmissions, a downlink-only state during which the primary radio of the UE is used at least for downlink transmissions, and a downlink and uplink state during which the primary radio of the UE is used for both downlink and uplink transmissions;
transmit an uplink message; and
modify operation of a hybrid automatic repeat request (HARQ) round trip time timer based at least in part on a first state of the plurality of power states that the UE is in, wherein the HARQ round trip time timer defines a minimum duration of time between transmission of the uplink message and receipt of a retransmission grant that pertains to retransmission by the UE of the uplink message.

25-26. (canceled)

27. The UE of claim 24, wherein, to modify operation of the HARQ round trip time timer, the one or more processors are individually or collectively operable to execute the code to cause the UE to:
initiate the HARQ round trip time timer based at least in part on the first state being the downlink-only state or the downlink and uplink state; or
refrain from initiating the HARQ round trip time timer based at least in part on the first state being the uplink-only state.

28. The UE of claim 24, wherein, to modify operation of the HARQ round trip time timer, the one or more processors are individually or collectively operable to execute the code to cause the UE to:
pause the HARQ round trip time timer based at least in part on the first state being the uplink-only state; or
pause the HARQ round trip time timer based at least in part on the first state being the downlink-only state.

29. The UE of claim 28, wherein the one or more processors are individually or collectively operable to execute the code to cause the UE to:
transition to a second state of the plurality of power states, the second state being one of the downlink-only state or the downlink and uplink state; and
resume the HARQ round trip time timer based at least in part on the second state being the downlink-only state or the downlink and uplink state.

30. A method for wireless communication by a user equipment (UE), comprising:
receiving control information that indicates a first schedule for the UE to transition between a plurality of power states, wherein the plurality of power states includes an uplink-only state during which a primary radio of the UE is used for uplink transmissions, and a second state during which the primary radio of the UE is used at least for downlink transmissions;
determining that the UE is to perform a radio link failure or beam failure detection operation; and
applying a second schedule for the UE to transition between the plurality of power states based at least in part on the determination that the UE is to perform the radio link failure or beam failure detection operation.
